(19) United States
(12) Patent Application Publication
(10) Pub. No.: US 2014/0133395 A1
(43) Pub. Date: May 15, 2014

(54) METHODS AND APPARATUS FOR IDENTIFICATION OF SMALL CELLS

(71) Applicant: Samsung Electronics Co., LTD, Suwon-si (KR)

(72) Inventors: Young-Han Nam, Plano, TX (US); Boon Loong Ng, Dallas, TX (US); Jianzhong Zhang, Plano, TX (US); Krishna Sayana, San Jose, CA (US); Aris Papasakellariou, Houston, TX (US)

(73) Assignee: Samsung Electronics Co. LTD, Suwon-si (KR)

(21) Appl. No.: 14/074,401

(22) Filed: Nov. 7, 2013

Related U.S. Application Data
(60) Provisional application No. 61/724,619, filed on Nov. 9, 2012.
(60) Provisional application No. 61/745,417, filed on Dec. 21, 2012.
(60) Provisional application No. 61/761,631, filed on Feb. 6, 2013.
(60) Provisional application No. 61/809,087, filed on Apr. 5, 2013.

(51) Int. Cl. H04B 7/04

(52) U.S. Cl. CPC H04B 7/0452
USPC 370/328

(57) ABSTRACT

Orthogonal multi-user, multiple input, multiple output (MU-MIMO) multiplexing capacity for demodulation reference signals (DMRSs) is increased without increasing the overhead in resource elements per physical resource block by using length-4 orthogonal cover codes (OCC-4). A base station switches between legacy DMRS antenna port mappings and OCC-4 mapping based upon either a transmission mode or a channel station information process configuration field value.

### CROSS-REFERENCE TO RELATED APPLICATIONS AND CLAIM OF PRIORITY

This application hereby incorporates by reference U.S. Provisional Patent Application No. 61/724,619, filed Nov. 9, 2012, entitled “METHODS AND APPARATUS FOR IDENTIFICATION OF SMALL CELLS,” U.S. Provisional Patent Application No. 61/745,417, filed Dec. 21, 2012, entitled “DEMODULATION REFERENCE SIGNALS FOR ADVANCED WIRELESS COMMUNICATION SYSTEMS,” U.S. Provisional Patent Application No. 61/761,631, filed Feb. 6, 2013, entitled “DEMODULATION REFERENCE SIGNALS FOR ADVANCED WIRELESS COMMUNICATION SYSTEMS,” and U.S. Provisional Patent Application No. 61/809,087, filed Apr. 5, 2013, entitled “DEMODULATION REFERENCE SIGNALS FOR ADVANCED WIRELESS COMMUNICATION SYSTEMS.”

### TECHNICAL FIELD

The present disclosure relates generally to coverage in wireless communications and, more specifically, to providing small cells having overlapping areas with other cells to improve coverage in a wireless communications system.

### BACKGROUND

Coverage within a geographic area for a wireless communications network that is generally provided by a base station may be augmented using small cells, to increase the capacity of the wireless communications network in that area. For example, the service areas along roadways that are heavily traveled, or the interiors of shopping malls or sports arenas where large numbers of users may congregate, may benefit from additional capacity. In adding small cells to augment a “macro” cell, however, issues such as resource allocation to particular user equipment (UE) within the overlapping coverage areas, hand-off and inter-cell interference must be addressed.

There is, therefore, a need in the art for improved utilization of small cells in wireless communications systems.

### SUMMARY

Orthogonal multi-user, multiple input, multiple output (MU-MIMO) multiplexing capacity for demodulation reference signals (DMRSs) is increased without increasing the overhead in resource elements per physical resource block by using length-4 orthogonal cover codes (OCC-4). A base station switches between legacy DMRS antenna port mappings and OCC-4 mapping based upon either a transmission mode or a channel station information process configuration field value.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, where such a device, system or part may be implemented in hardware that is programmable by firmware or software. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a high level diagram illustrating an exemplary wireless communication system within which small cell deployment may be implemented in accordance with various embodiments of the present disclosure;

FIG. 1A is a high level block diagram of the functional components of the base station and small cells within the network of FIG. 1;

FIG. 1B is a front view of wireless user device employed the network of FIG. 1;

FIG. 10 is a high level block diagram of the functional components of the wireless user device of FIG. 1B;

FIG. 2 illustrates, at a high level, the initial access procedure necessary for compatibility with legacy LTE specifications;

FIG. 3 illustrates the primary synchronization signals (PSS)/secondary synchronization signals (SSS)/PBCH resource element (RE) mapping necessary for compatibility with legacy (Rel-8, 9, 10) LTE systems;

FIG. 4 is an illustration of the three options for implementation of NCTs;

FIGS. 5A and 5B illustrate two cases for an NCT cell to neighbor a backward compatible cell;

FIGS. 6A and 6B illustrate signal diagrams for a quasi-cell in accordance with the present disclosure co-channel deployed with an NCT cell and with a backward compatible cell, respectively;

FIG. 7 illustrates signal diagrams for a convertible-type cell in accordance with the present disclosure;

FIGS. 8A, 8B and 8C illustrate network configuration snapshots for the small cells in order to achieve energy saving and to adapt the operation based upon the UE-type population in accordance with the present disclosure;

FIG. 9 illustrates the resource elements used for UE-specific reference signals for normal cyclic prefix for antenna ports 7, 8, 9 and 10 for one specification;

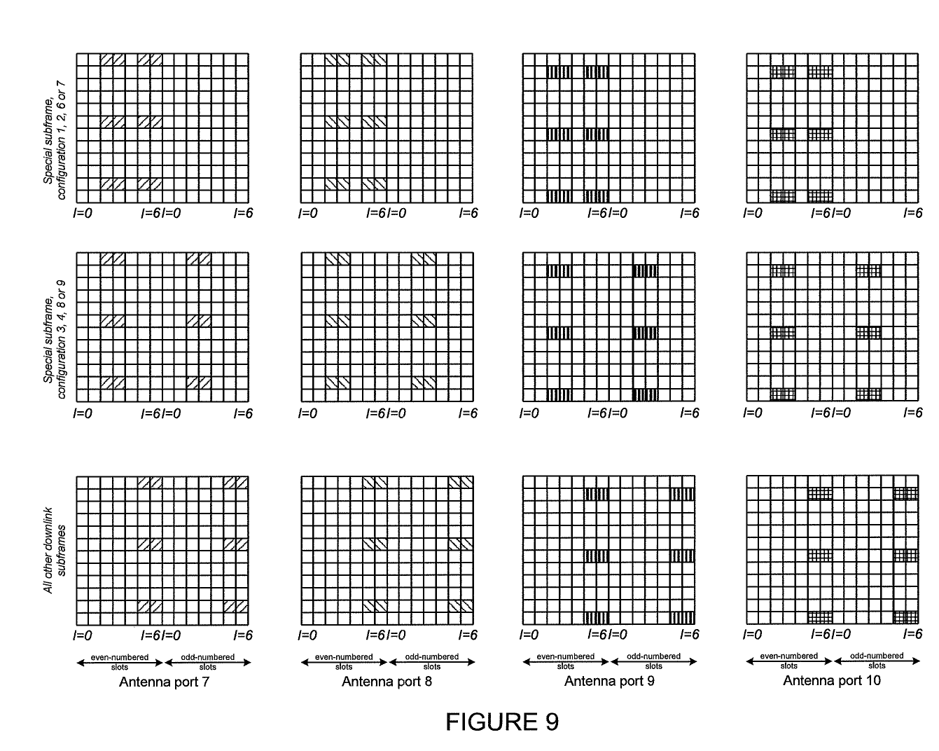

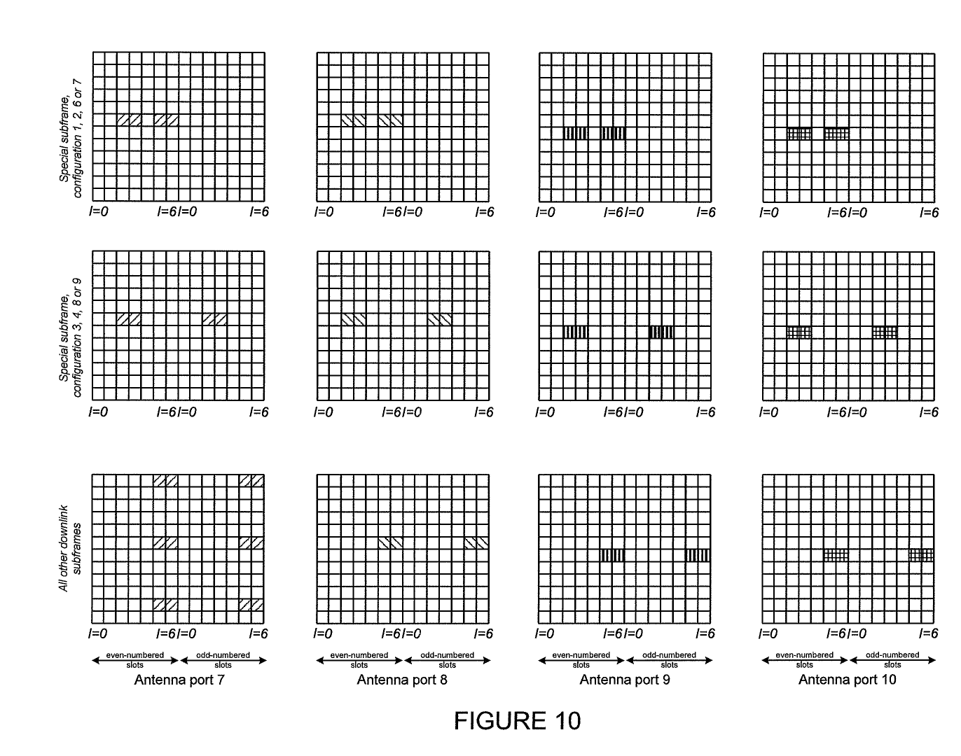

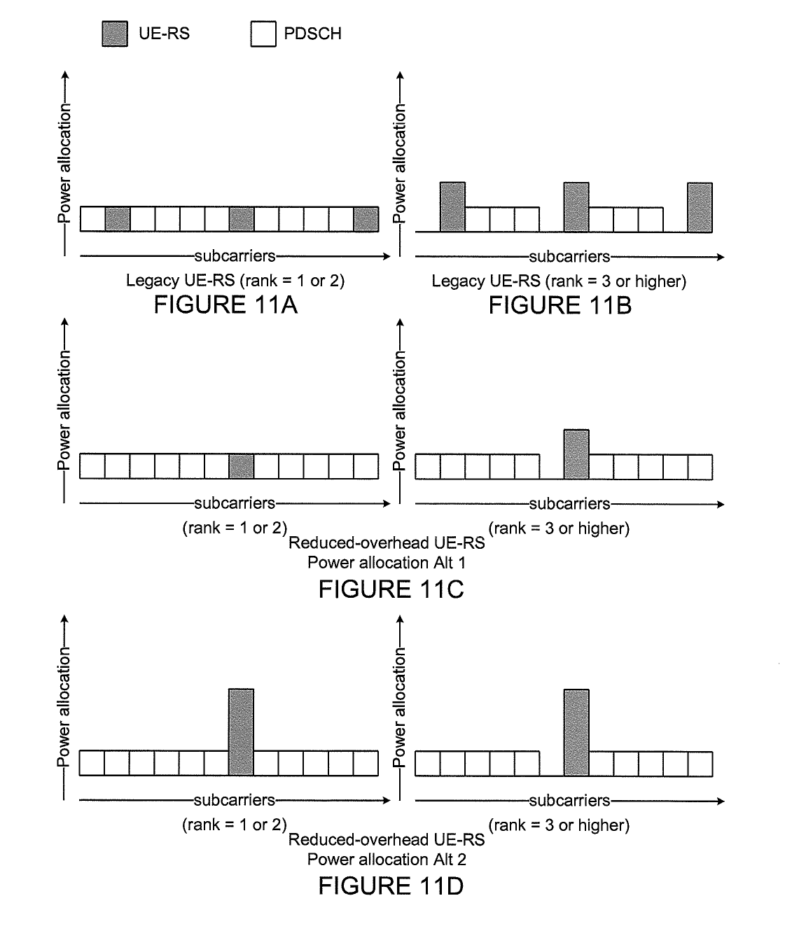

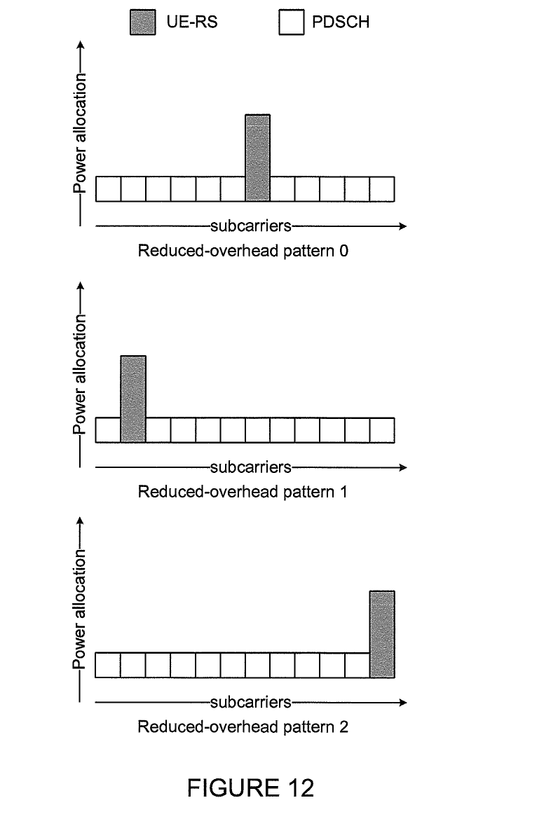

FIG. 10 illustrates mapping of UE-specific reference signals to resource elements of a resource block (with normal cyclic prefix) according to one embodiment of the present disclosure;

FIGS. 11A through 11D illustrate UE-RS power boosting aspects of employing reduced-overhead UE-specific reference signals according to one embodiment of the present disclosure; and

FIG. 12 illustrates switching among different reduced-overhead UE-RS patterns when employing reduced-overhead UE-specific reference signals according to one embodiment of the present disclosure.

### DETAILED DESCRIPTION

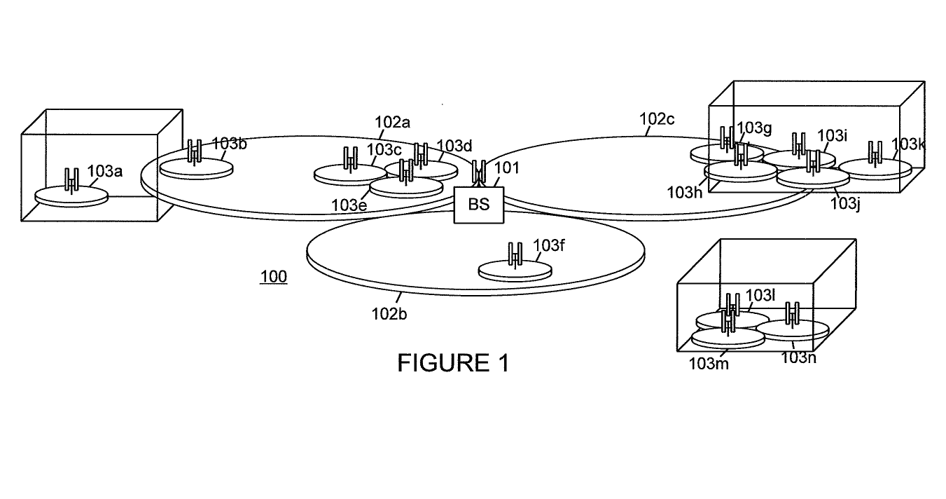

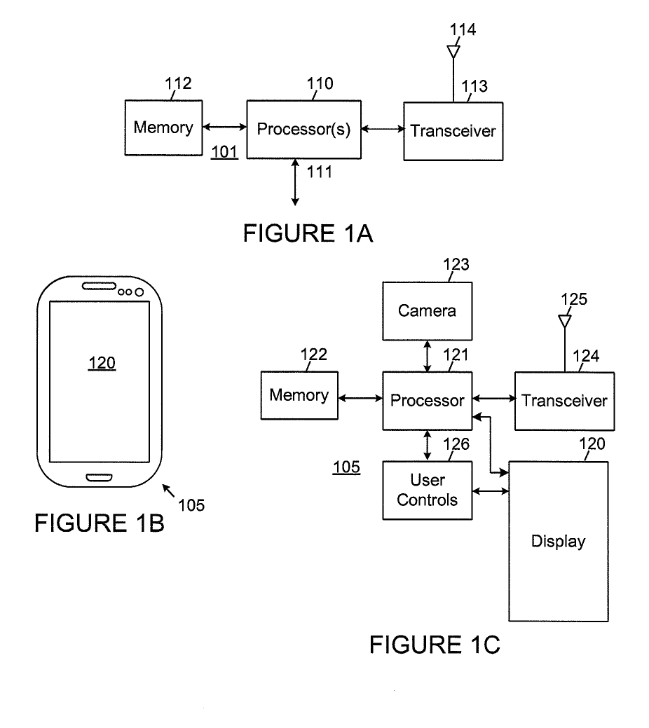

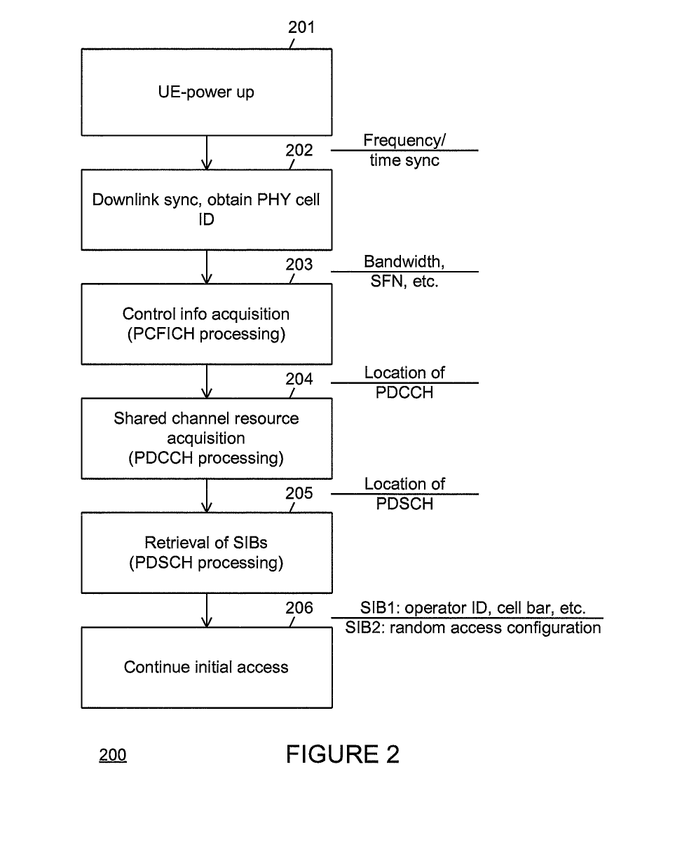

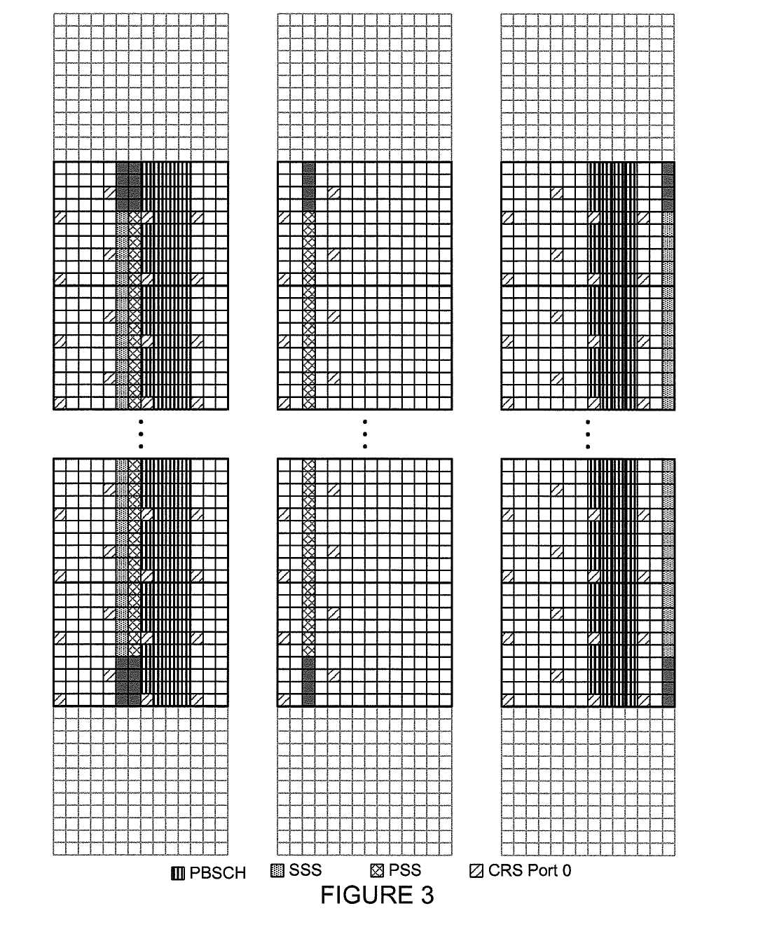

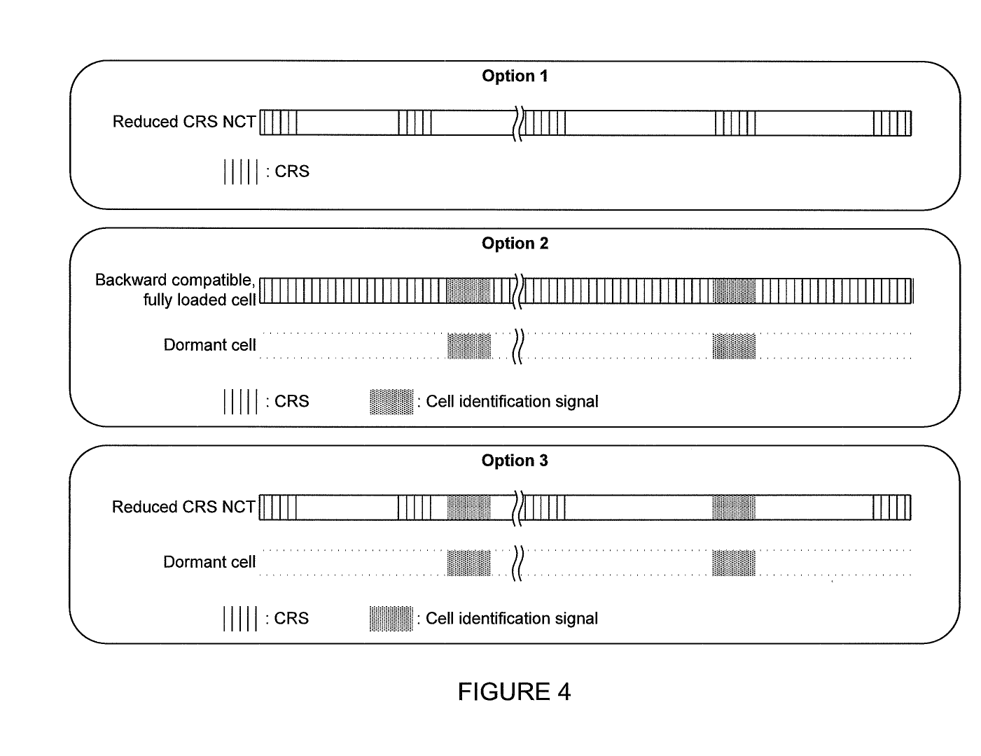

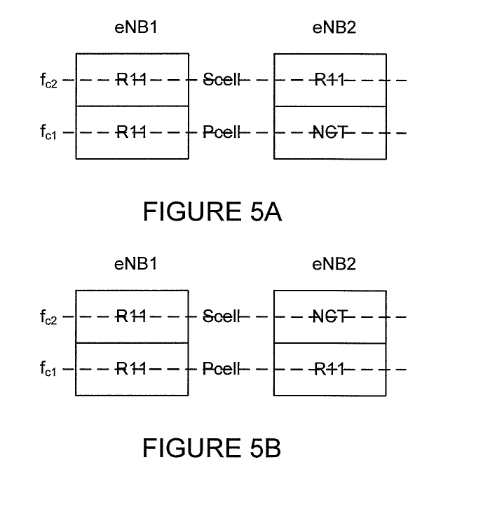

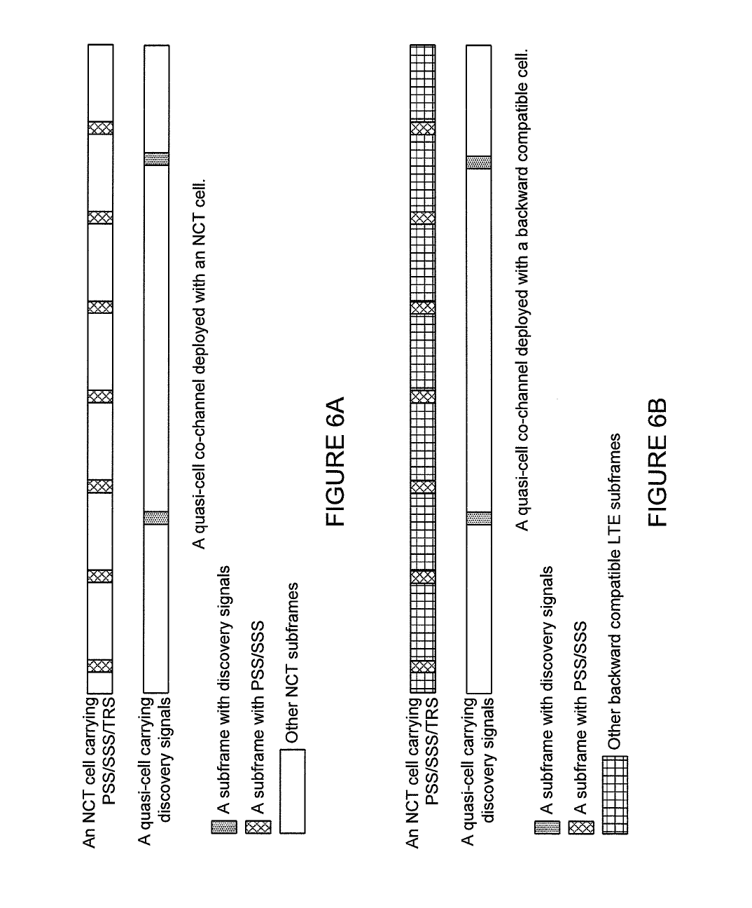

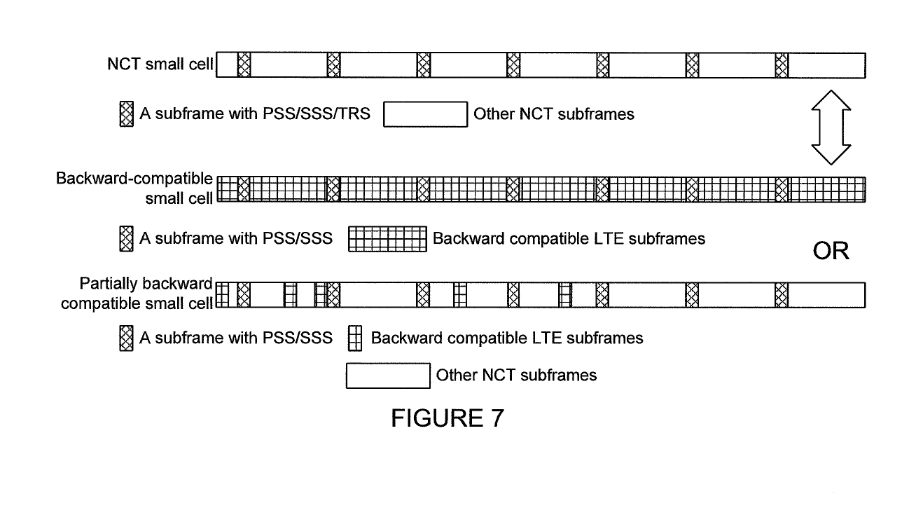

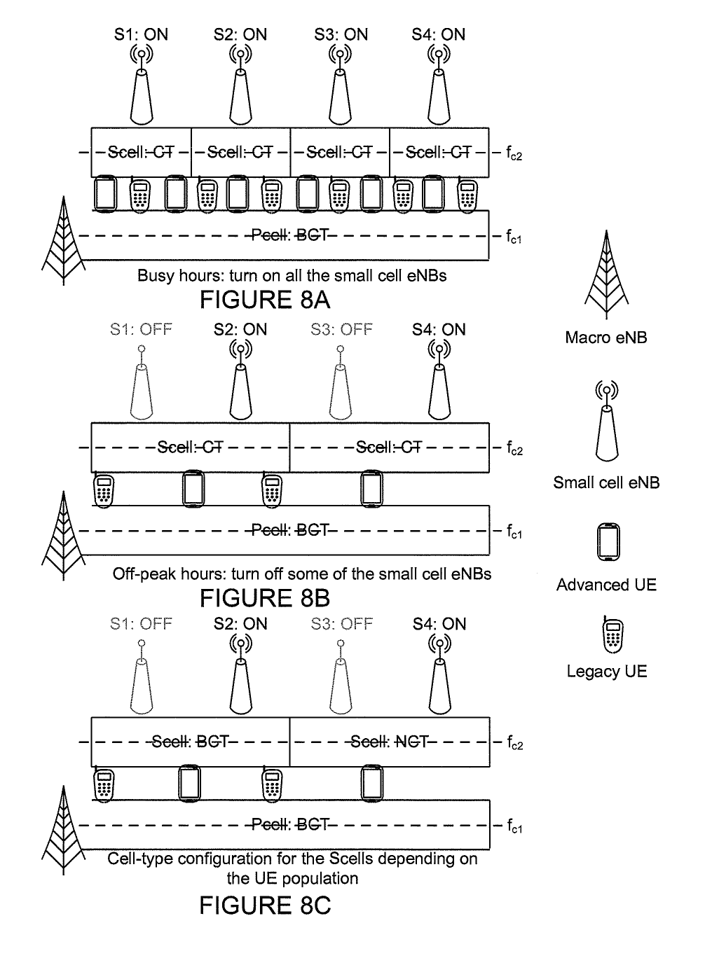

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein:

[REF1]—3GPP TS 36.211 v10.1.0, “E-UTRA, Physical channels and modulation”;
[REF2]—3GPP TS 36.212 v10.1.0, “E-UTRA, Multiplexing and Channel coding”;

### [REF5]—3GPP TS 36.213 v10.1.0, “E-UTRA, Physical Layer Procedures”;

### [REF4]—Draft 3GPP TR 36.932 v0.1.0, “Scenarios and Requirements for Small Cell Enhancement for E-UTRA and E-UTRAN”;

### [REF5]—U.S. Patent Application Publication No. 2012/0044902 Al, Huawei, Feb. 23, 2012; and

[REF6]—R1-130691, Initial evaluation of DM-RS reduction for small cell, LG Electronics.

Small Cell Enhancement

3GPP TR 36.932 [REF4] describes target scenarios of a small-cell study, indicating that small cell enhancement should target deployment both with and without macro coverage, both outdoor and indoor small cell deployments, and both ideal and non-ideal backhaul. In addition, both sparse and dense small cell deployments should be considered.

FIG. 1 is a high level diagram illustrating an exemplary network within which small cell deployment may be implemented in accordance with various embodiments of the present disclosure. FIG. 1 illustrates small cell deployment with/without macro coverage, where F1 and F2 are the carrier frequencies for the macro layer and the local-node layer, respectively. The network 100 of FIG. 1 includes a base station 101, also sometimes referred to as an access point or an evolved Node B (“eNodeB” or “eNB”), providing wireless communications with fixed or mobile user devices within a coverage area corresponding to macro cell regions 102a-102c. Three generally equally-sized macro cell regions or “sectors” 102a-102c are depicted in FIG. 1, although the number and size of such coverage area regions may vary for different implementations. To improve capacity, additional wireless small cells 103a-103n may be established with coverage at least partially overlapping that of base station 101 or augmenting. Each small cell 103a-103n has a structure functionally similar to that of base station 101 and operates in a similar manner. The small cells 103a-103n operate in conjunction with base station 101 and with each other in the manner described in further detail below to improve wireless communications service for user equipment (UE) operating within the geographic coverage area of base station 101 or within an extended coverage area provided by small cells 103a-103n.

One or more user device(s) (not shown in FIG. 1), which may also be referred to as user equipment (UE) or a mobile station (MS), are located within the coverage area of base station 101 and/or with the coverage areas of small cells 103a-103n. As noted above, the user device(s) may be either fixed or mobile, and accordingly may comprise a “smart” phone or tablet device capable of functions other than wireless voice or data communications or may be a laptop or desktop computer, a video receiver, or other wireless device. The mobile user devices may move within the coverage area of base station 101 and within or between the coverage areas of small cells 103a-103n.

Coverage area regions 102a-102c in FIG. 1 are depicted as coverage using “macro” layers operating using frequency F1 while small cells 103a-103n are depicted as “local-node” layers operating using frequency F2. As shown, the coverage area regions 102a-102c are positioned and operate with substantially contiguous (i.e., only slightly overlapping) coverage areas while small cells 103a-103n are positioned and operate with coverage areas either completely non-overlapping with the coverage area regions 102a-102c, partially overlapping with such coverage area regions, or fully overlapping such coverage area regions. As also shown, the coverage area regions 102a-102c and coverage areas of small cells 103a and 103g-103n may be completely or partially within a building, depicted as wire frame rectangular boxes in FIG. 1.

FIG. 1A is a high level block diagram of the functional components of the base station and small cells from the network of FIG. 1, while FIG. 1B is a front view of wireless user device that may be employed within the network of FIG. 1 and FIG. 10 is a high level block diagram of the functional components of that wireless user device.

Base station 101 and each small cell 103a-103n includes one or more processor(s) 110 coupled to a network connection 111 over which signals may be received and selectively transmitted—that is, a connection to a backhaul network and/or to the Internet. The base station 101 and each small cell 103a-103n also includes memory 112 containing an instruction sequence for processing communications in the manner described below, and data used in the processing of communications. The base station 101 and each small cell 103a-103n each further include a transceiver 113 and associated antenna(a) 114 for wireless communications with user equipment.

User device(s) 105, not depicted in FIG. 1 but shown diagrammatically in FIG. 1B and including components corresponding to those depicted in FIG. 1C, is a mobile phone with wireless data communications capabilities in an exemplary embodiment and includes a display 120 on which user controls may be displayed. A processor 121 coupled to the display 120 controls operation of the user device. The processor 121 and other components within the user device 105 are either powered by a battery (not shown), which may be recharged by an external power source (also not shown), or alternatively by the external power source. A memory 122 coupled to the processor 121 may store or buffer instructions and content for wireless communications with any of base station 101 and small cells 103a-103n. User controls (e.g., buttons or touch screen controls displayed on the display 120) are employed by the user to control the operation of mobile device 105 in accordance with known techniques.

With and without Macro Coverage

Referring back to FIG. 1, in the exemplary embodiment, small cell enhancement should target deployment in which small cell nodes 103a-103n are deployed under the coverage of one or more than one overlaid Evolved Universal Terrestrial Radio Access Network (E-UTRAN) macro-cell layer(s) 102a-102c in order to boost the capacity of already deployed cellular network. Two scenarios can be considered:
where the UE is in coverage of both the macro cell and the small cell simultaneously; and
where the UE is not in coverage of both the macro cell and the small cell simultaneously (e.g., in the coverage area of the macro cell only).
   FIG. 1 also shows the scenario where small cell nodes 103a and 103k-103n are not deployed even partially under the coverage of one or more overlaid E-UTRAN macro-cell layer(s) 102a-102c. This scenario is also the target of the small cell enhancement.

Sparse and Dense

Small cell enhancement should consider sparse and dense small cell deployments. In some scenarios (e.g., hotspot indoor/outdoor places, etc.), only a single or a few small cell node(s) are sparsely deployed, for example to cover the traffic hotspot(s). Meanwhile, in some scenarios (e.g., dense urban residential areas, a large shopping mall, etc.), a lot of small cell nodes are densely deployed to support huge traffic over a relatively wide area covered by the small cell nodes. Furthermore, smooth future extension/scalability (e.g.,: from sparse to dense, from small-area dense to large-area dense, or from normal-dense to super-dense) should be considered. For throughput performance, dense deployments should be prioritized compared to sparse deployments. For mobility/connectivity performance, both sparse and dense deployments should be considered with equal priority.

Synchronization

Both synchronized and un-synchronized scenarios should be considered between small cells as well as between small cell and macro layers. For specific operations such interference coordination, carrier aggregation and inter-eNB coordinate multi-point (COMP) communications, small cell enhancement can benefit from synchronized deployments with respect to small cell search/measurements and interference/resource management. Therefore time synchronized deployments of small cell clusters are preferably prioritized and new means to achieve such synchronization should be considered.

Spectrum

Small cell enhancement should address the deployment scenario in which different frequency bands are separately assigned to macro layer and small cell layer, respectively, where F1 and F2 correspond to different carriers in different frequency bands as described above.

Small cell enhancement should be applicable to all existing and as well as future cellular bands, with special focus on higher frequency bands, e.g., the 3.5 giga-Hertz (GHz) band, to enjoy the more available spectrum and wider bandwidth.

Small cell enhancement should also take into account the possibility for frequency bands that, at least locally, are only used for small cell deployments.

Co-channel deployment scenarios between macro layer and small cell layer should be considered as well. The duplication of activities with existing and coming standards items should be avoided.

Some example spectrum configurations are:

1. Carrier aggregation on the macro layer with bands X and Y, and only band X on the small cell layer;
2. Small cells supporting carrier aggregation bands that are co-channel with the macro layer; and
3. Small cells supporting carrier aggregation bands that are not co-channel with the macro layer.

One potential co-channel deployment scenario is dense outdoor co-channel small cells deployment, considering low mobility UEs and non-ideal backhaul, where all small cells are under the macro coverage.

Small cell enhancement should be supported irrespective of duplex schemes—frequency division duplex (FDD) or time division duplex (“TDD”)—for the frequency bands for macro layer and small cell layer. Air interface and solutions for small cell enhancement should be band-independent, and aggregated bandwidth per small cell should be no more than 100 mega-Hertz (MHz), at least for Rel-12.

System Information Acquisition in Release 8/10

FIG. 2 illustrates, at a high level, the initial access procedure necessary for compatibility with legacy LTE specifications in accordance with embodiments of the present disclosure. The process 200 begins with UE power up (step 201), frequency and time synchronization, then downlink synchronization and acquisition of the physical layer (PHY) cell identification (ID) (step 202). Legacy UEs acquire system information block 1 (SIB1) and system information block 2 (SIB2) (step 205), which are in the Physical Downlink Shared CHannel (PDSCH), after decoding the Physical Broadcast CHannel (PBCH), acquiring control information using the Physical Control Format Indicator CHannel (PCFICH) (step 203), and acquiring shared channel resources based on the Physical Downlink Control CHannel (PDCCH) (step 204). SIB1 includes information on operator identification (ID), cell barring, etc., while SIB2 includes information on the random access configuration. Initial access by the UE then continues (step 206).

FIG. 3 illustrates the primary synchronization signals (PSS)/secondary synchronization signals (SSS)/PBCH resource element (RE) mapping necessary for compatibility with legacy (Rel-8, 9, 10) LTE systems. Each (vertical) group of resource blocks (RBs) depicts the middle six RBs from a subframe within which PSS/SSS are transmitted, with the topmost and bottommost RBs in FIG. 3 being part of the remainder of the RBs within the respective subframe. For each group, the even numbered slots with indices 1=0 to 1=6 and the odd numbered slots with indices 1=0 to 1=6 are shown. The leftmost group is an FDD configuration (subframe 0); the center group is a TDD configuration (subframe 1) used for configuration 1, 2 6 or 7; and the rightmost group is another TDD configuration (subframe 0). The location of resource elements (REs) allocated to the PBCH, PSS, SSS and CRS Port 0 are shown for the respective configurations.

RP-121186 proposes introduction of dormant cells in the following manner:

Some of the main motivations for defining new carriers types (NCT) were reducing energy use and reducing generated interference due to common reference signal transmission by partially loaded or unloaded cells. Clearly the Rel-11 NCT design, which is also part of the NCT Work Item Description (WID) [REF4] is a step towards this goal; however, that design achieves only moderate gains. Another, and possibly more natural, alternative is simply to enable turning off signal transmission completely in unloaded cells. This could be used in conjunction with the Rel-11 NCT design or used in itself. This then gives the following schemes to consider:

Option 1: Reduced common reference signal (CRS) (Rel-11 NCT), (useful mainly in macro cells);
Option 2: Dormant mode of unloaded cells, (useful in both small cells and macro cells); and
Option 3: Dormant mode of unloaded cells+Reduced CRS.
FIG. 4 is an illustration of the three options described above. A high level comparison of the three schemes described above is provided in TABLE I below:

TABLE I
Comparison of alternative overhead reduction schemes

| | Reduced CRS | | Dormant mode |
|---|---|---|---|
| | regardless of | Dormant mode | of unloaded |
| | loading | of unloaded | cells + |
| | (Rel-11 NCT) | cells | Reduced CRS |
| Interference reduction | 80%¹ | 98%² | 98% |
| compared to Rel-10 | | | |
| (5 MHz, with no | | | |
| MBSFN) | | | |
| Energy reduction | 80% | 98% | 98% |
| compared to Rel-10 | | | |
| (assuming 1 ms On/ | | | |
| Off granularity)³ | | | |
| Spectral efficiency | Close to 0% | 0% | 0% |
| gain (overhead | since CRS | | |
| reduction) | is replaced | | |
| | with DM-RS | | |
| Backward | Full loss⁴ | Partial loss⁵ | Full loss⁴ |
| compatibility | | | |

¹Four out of five subframes do not contain CRS.
²Assume cell detection signals equivalent to 20 CRS symbols transmitted once every 320 milli-seconds (ms).
³Makes assumption that Tx circuitry is switched On/Off on a per-subframe basis rather than on a per-symbol basis.
⁴Rel-8-11 UEs are not able to get service in NCT.
⁵Rel-8-11 UEs can get service when the cell is active, although some mobility problems can be expected.

The Multicast-Broadcast Single-Frequency Network (MBSFN) option of LTE and DeModulation Reference Signals (DM-RS) are referenced in the above analysis.

In R1-124931, two cases were identified for an NCT cell to neighbor a backward compatible cell (e.g., R11 compatible cell), as shown in FIGS. 5A and 5B. In Case 1 (FIG. 5A), an NCT cell neighbors an R11 cell and is a primary cell (Pcell) for some UEs on the same carrier frequency f_{c1} (F1). In case 2 (FIG. 5B), an NCT cell neighbors an R11 cell and is a secondary cell (Scell) on the same carrier frequency f_{c2} (F2).

FIGS. 6A and 6B illustrate signal diagrams for a quasi-cell in accordance with the present disclosure co-channel deployed with an NCT cell and with a backward compatible cell, respectively. In this disclosure, a backward compatible type (BCT) cell/subframe refers to a subframe/cell complying with the legacy specification (i.e., at least one of 3GPP LTE Release 8, 9, 10, 11). FIGS. 6A and 6B illustrating signaling for a quasi-cell (e.g., a small cell 103a-103n) that is co-channel deployed on a carrier (or a carrier frequency) together with a cell (e.g., base station 101); the quasi-cell and the cell may have been placed in two geographically separated locations. The cell here can be used as either Pcell or Scell for a particular UE, as discussed in connection with FIGS. 5A and 5B. A quasi-cell is identified by a quasi-cell specific discovery signal (and discovery ID), depicted as the bottom signal sequences including periodic subframes with a discovery signal, for example transmitted without PSS/SSS and PCI, transmitted on a different frequency band than used for the PDSCH of legacy UEs with overlapping coverage, and/or transmitted with a coding not recognized by legacy UEs. An advanced UE can identify a quasi-cell by detecting a quasi-cell specific discovery signal, while a legacy UE cannot identify the quasi-cell. The network can make use of the quasi-cell to transmit PDSCH to both the legacy UE and the advanced UE. When the advanced UE receives PDSCH from the quasi-cell, the advanced UE may then be aware that the advanced UE receives the PDSCH from the quasi-cell. Even when the legacy UE receives PDSCH from the quasi-cell, the quasi-cell operation is transparent to the legacy UE, and the legacy UE does not recognize or know of the existence of the quasi-cell as the legacy UE operates according to the legacy specification where no specific protocols are defined for the quasi-cells. It is noted that the quasi-cell is not a traditional cell, as the quasi-cell does not carry PSS/SSS to be used for identifying the cell and physical cell ID (PCI).

When the cell is configured to an advanced UE as an Scell, the advanced UE synchronizes to the Scell (and to the quasi-cell when the quasi-cell is close to the Scell) relying on PSS/SSS, and may receive other configurations with respect to the Scell from the Pcell. The advanced UE can be configured to receive PDSCH and other downlink (DL) physical signals from either the cell or the quasi-cell or both. In this case, the advanced UE can be configured with two virtual cell IDs (VCIDs), one (VCID1) for the cell and the other (VCID2) for the quasi-cell. When the advanced UE is configured (or scheduled) to receive a PDSCH from the cell, then VCID1 is used for PDSCH and/or UE-RS scrambling for the PDSCH. When the advanced UE is configured (or scheduled) to receive a PDSCH from the quasi-cell, then VCID2 is used for PDSCH and/or UE-RS scrambling for the PDSCH. The configuration of the DL physical signal origin can change either dynamically or semi-statically. When the configuration changes dynamically, a one-bit field can included in a DL scheduling assignment DCI format (e.g., DCI formats 1A, 2B, 2C, 2D and any extension of these DCI formats) to indicate the DL physical signal origin, i.e., whether the DL physical signal is from the cell (in which case VCID1) or the quasi-cell (in which case VCID2).

In some embodiments associated with FIG. 6A, quasi-cells are co-channel deployed on a first carrier with a cell that is an NCT cell carrying PSS/SSS/Timing Reference Signal (TRS). A serving cell on the first carrier can be configured as an Scell for the advanced UEs. In this case, a BCT serving cell on a second carrier can be a Pcell for the legacy UEs and the advanced UEs and that BCT serving cell provides the basic coverage. The legacy UEs can only access the cell on the second carrier, while the advanced UEs can access both the first and the second carriers.

In some embodiments associated with FIG. 6B, quasi-cells are co-channel deployed on a first carrier with a cell that is a BCT (e.g., R11) cell. A serving cell on the first carrier can be configured as an Scell or a Pcell for both the advanced UEs and the legacy UEs. In cases where the serving cell on the first carrier is configured as an Scell, a BCT serving cell on a second carrier can be a Pcell for both the legacy UEs and the advanced UEs and provide the basic coverage.

The deployment scenario shown in FIG. 6A can provide cleaner and more performance-optimal designs for the NCT. On the other hand, the deployment scenario shown in FIG. 6B has a benefit of being backward compatible, so that legacy UEs can also access the carrier frequency where the quasi-cells are co-channel deployed.

In FIGS. 6A and 6B, the quasi-cell carries PSS/SSS, where the PSS/SSS sequences are identical to those of the legacy LTE carrier (or Rel-8 compliant during the initial access), but the time location—that is, the Orthogonal Frequency Division Modulation (OFDM) symbol numbers to carry PSS/SSS—could be different from those for the legacy LTE carrier. The macro layer(s) can be deployed as either a legacy (one of 3GPP LTE Rel-8, Rel-9, Rel-10 and Rel-11) LTE cell (FIG. 6B) or a new-carrier-type (NCT) cell (FIG. 6A). On the other hand, the quasi-cell may not carry PSS/SSS, but may instead carry a discovery signal for helping advanced UEs discovering the quasi-cells.

In the first circumstance described above, an advanced UE can acquire synchronization to the quasi-cell relying on PSS/SSS (and TRS or CRS) transmitted by the quasi-cell. Once the UE acquires synchronization from PSS/SSS, the advanced UE obtains a physical cell ID (PCI) and cyclic prefix (CP) length (e.g., whether the CP length is normal-CP or extended-CP). In the legacy LTE system, PCI ranges from 0 to 503.

On the other hand, for the discovery and synchronization to the quasi-cells, the advanced UE relies on the discovery signal transmitted by the quasi-cell. Once the UE discovers a quasi-cell relying on the discovery signal, the UE obtains a discovery ID. In one example, a discovery ID is used to generate at least one of a set of time-frequency locations where a discovery channel is transmitted and the (scrambling) sequence for the discovery signal. In this case, when a UE detects strong energy across the set of time-frequency locations, the UE can identify the existence of a quasi-cell having the discovery ID (using the sequence).

The discovery ID detected from the discovery signals would be able to have wider range of values than otherwise available. In one example, the value range for the discovery ID is chosen as [0, MSCI], where MSCI is the maximum possible value for the discovery ID, which is greater than 503, e.g., 2006. In another example, to distinguish the discovery ID and PCI from the values, the value range for the discovery ID is chosen as [504, MSCI], where MSCI is the maximum possible value for the discovery ID. In one example, when 2000 discovery IDs are defined, MSCI=1000+504−1=2503. It is noted that the number of discovery IDs should be large enough to assign a number of small cells in a geographical area, and here 2000 discovery IDs are considered just as an example.

When an advanced UE is configured with a serving cell on the carrier according to the embodiments associated with FIGS. 6A and 6B, the advanced UE may acquire synchronization by listening to the PSS/SSS/TRS transmitted by the macro, but at the same time the advanced UE may receive/transmit physical signals (e.g., PDSCH, PUSCH, ePDCCH, SRS, etc.) from/to a nearby quasi-cell. For transmission/reception of the physical signals from/to the quasi-cell, the advanced UEs can be configured with a number of virtual cell IDs according to one of the following alternative methods:
In one alternative (Alt 1), a virtual cell ID (VCID) to replace physical cell IDs in at least one of the following occasions is determined by a function of the discovery ID and the PCI. In another alternative (Alt 2), a virtual cell ID (VCID) to replace physical cell IDs in at least one of the following occasions is explicitly radio resource control (RRC) configured.
Scrambling initialization of at least one of the DL UE-specific reference signals (RS for antenna ports 7˜14), DL demodulation reference signals for ePDCCH (RS for antenna ports 107-110), and CSI reference signals (RS for antenna ports 15-22).
Scrambling initialization of the physical DL/UL signals (enhanced Packet Data Control CHannel or “ePDCCH,” Physical Downlink Shared CHannel or “PDSCH,” Physical Uplink Shared CHannel or “PUSCH”).
Determination of uplink (UL) reference signal (RS) base sequences and initialization of UL RS sequence (group) hopping (for UL DMRS, sounding reference signals (SRS) and Physical Uplink Control CHannel (PUCCH)).
   Example functions for Alt 1 are:
VCID=PCI+(discovery ID), where the range of discovery ID is [504, MSCI].
VCID=PCI+(discovery ID)·29, where the range of discovery ID is [0, MSCI].
   These example functions assign each small cell a VCID that does not coincide with the legacy (R11) cell's VCID and PCI, which is useful for interference randomization and area splitting. This is because the range of the quasi-cell's VCID does not overlap with the range of rgw R11 cell's VCID as well as the range of PCI.

Convertible-Type Cell

FIG. 7 illustrates that a new type of cell called “convertible-type cell,” in which a small cell can switch cell (subframe) types between NCT and BCT for periods of time. This change in cell types allows a cell to opportunistically operate in a backward compatible manner only when necessary, thereby reducing the network's energy consumption and the inter-cell interference. Furthermore, to allow for legacy UEs Reference Signal Received Power (RSRP) measurement on the NCT, PSS/SSS/TRS on the NCT can be transmitted in the identical way as the PSS/SSS/CRS are transmitted on the backward compatible cell. In this case, the RSRP measurement should be based upon TRS (or reduced CRS).

When the subframe type is BCT, the subframe can be either an MBSFN subframe or a non-MBSFN subframe. In an MBSFN subframe, CRSS are transmitted only in the first two OFDM symbols of the subframe, while in a non-MBSFN subframe, full CRSs are transmitted according to the CRS pattern for Antenna Ports (APs) 0-NAP, where NAP is the number of configured CRS APs. In each BCT subframe, PDCCH, PCFICH and Physical Hybrid-Automatic Repeat request (ARQ) Indicator CHannel (PHICH) are transmitted in the first a few OFDM symbols of the subframe.

When the subframe type is NCT and when the subframe does not carry PSS/SSS, no CRSs are mapped in the subframe. In addition, in each NCT subframe, none of PDCCH, PCFICH and PHICH are transmitted, and hence PDSCH can be transmitted from the first OFDM symbol.

To illustrate a use case of the convertible quasi-cell signaling illustrated in FIG. 7, first consider a legacy UE (R8-R11) that approaches an NCT small cell. The legacy UE relies on the legacy mechanism of performing RSRP measurement on the NCT small cell. The legacy UE may be able to perform the RSRP measurement, even though the legacy UE may assume that the small cell is actually a backward compatible cell and may try to measure RSRP in those subframes where CRS is not transmitted. In such a case, the RSRP measured by the legacy UE is likely to be distorted (in fact, to be degraded), and some of the legacy UE's RSRP reporting triggering conditions may not be satisfied even if the NCT cell is nearby. However, assuming that these issues associated with legacy UE's RSRP reporting can be mitigated and that the legacy UE can report RSRP reasonably well for the small cell NCT, the network can determine that the legacy UE is proximate to the NCT small cell. To allow for the legacy UEs to receive/transmit from/to the small cell when the legacy UE is nearby, the network can convert the cell type of the small cell from the NCT to BCT (backward-compatible small cell), or use a subset of subframes for the backward compatible transmissions (partially backward-compatible small cell).

In some BCT subframes, legacy CRS(s) may be transmitted to support the legacy PDCCH transmission and legacy TMs relying on legacy CRS.

In some BCT subframes, in order to comply with the legacy specification, the legacy rate matching of the PDSCH (around the CRS REs) for the legacy UEs can be applied, even if the legacy CRS is not transmitted.

Advanced UE Behavior for the Convertible-Type Cell:

The network can configure an Scell for an advanced UE that is a convertible-type cell. The type of Scell can be either explicitly indicated by an information element conveyed by an RRC signal configuring the Scell or implicitly indicated by the OFDM symbol location of PSS/SSS (in case the OFDM symbol location of PSS/SSS in the convertible-type cell is different from the BCT cells). Here, the information element can be of the ENUMERATION type, and the possible information element values would be codes for {BCT, NCT, CT}, where CT implies convertible-type.

When the network configures a convertible-type cell to an advanced UE, some impact to any advanced UE that has been receiving/transmitting from/to the small cell is to be expected. In contrast to the legacy UEs, the advanced UEs are aware that the small cell is a convertible type cell. The system protocol may therefore be designed so that the advanced UEs take advantage of the knowledge of the cell type. When the advanced UE knows the cell (or subframe) type, the advanced UEs can:
Perform RSRP measurement differently depending upon the cell type (Method X).
Perform PDSCH rate matching differently depending upon the cell (or subframe) type (Method Y).
Perform channel quality information (CQI) estimation differently depending upon the cell (or subframe) type (Method Z).

Subframe-Type Indication:

Furthermore, the subframe type can be indicated to the advanced UE so that the advanced UE can apply the proper method. The indication of the subframe type can be done in a UE-specific RRC configuration containing a 40-bit bitmap field, the i-th bit of which indicates whether the i-th subframe of a super-frame of Nₛᵤₚₑᵣ (e.g., 40) subframes is BCT or NCT. For example, if the i-th bit is 1, the i-th subframe is NCT; if the i-th bit is 0, the i-th subframe is BCT.

Number of CRS Antenna Ports when the CT Cell Becomes BCT

The TRS in the NCT is transmitted on the resource elements (REs) where the legacy CRS for AP 0 is transmitted. To seamlessly support legacy operation, the number of CRS ports should not vary over subframes. Hence, the number of CRS APs in the BCT cell (or subframe) should be constant, which is 1. In one example scenario, the cell-type switching can happen only in an Scell on a first carrier, and a UE maintains a basic connection with the network in a Pcell on a second carrier. Then, if the eNB 100 configures an SCell that is a convertible type (between NCT and backward-compatible-type) for the advanced UE, the number of CRS APs in BCT subframes in the convertible-type cell is constant, i.e., one.

Method X:

When the cell type is either NCT or convertible-type, the advanced UEs should perform RSRP measurement only in those subframes where PSS/SSS/TRS are transmitted, and rely on TRS (or reduced CRS); on the other hand, when the cell type is BCT, the advanced UEs can rely on the legacy mechanism to perform RSRP measurement without any subframe restriction.

A few alternatives to inform the advanced UEs of the cell type are considered below.

According to the current agreement in 3GPP RAN1, the subframes where PSS/SSS/TRS are transmitted are subframes #0 and #5.In 36.331 v10.5.0, the following pseudo-code is captured for the E-UTRA measurement object, i.e., MeasObjectEUTRA information element (IE):

| | |
|---|---|
| MeasObjectEUTRA ::= | SEQUENCE { |

| carrierFreq | ARFCN-ValueEUTRA, | | |
|---|---|---|---|
| allowedMeasBandwidth | AllowedMeasBandwidth, | | |
| presenceAntennaPort1 | PresenceAntennaPort1, | | |
| neighCellConfig | NeighCellConfig, | | |
| offsetFreq | Q-OffsetRange | DEFAULT dB0, | |
| -- Cell list | | | |
| cellsToRemoveList | CellIndexList | OPTIONAL, | -- Need ON |
| cellsToAddModList | CellsToAddModList | OPTIONAL, | -- Need ON |
| -- Black list | | | |
| blackCellsToRemoveList | CellIndexList | OPTIONAL, | -- Need ON |
| blackCellsToAddModList | BlackCellsToAddModList | OPTIONAL, | -- Need ON |
| cellForWhichToReportCGI | PhysCellId | OPTIONAL, | -- Need ON |
| ..., | | | |
| [[measCycleSCell-r10 | MeasCycleSCell-r10 | OPTIONAL, | -- Need ON |

measSubframePatternConfigNeigh-r10 MeasSubframePatternConfigNeigh-r10

| | |
|---|---|
| OPTIONAL | -- Need ON |

]]

}

| | |
|---|---|
| CellsToAddModList ::= | SEQUENCE (SIZE (1..maxCellMeas)) OF |

CellsToAddMod

| | |
|---|---|
| CellsToAddMod ::= | SEQUENCE { |

| | |
|---|---|
| cellIndex | INTEGER (1..maxCellMeas), |
| physCellId | PhysCellId, |
| cellIndividualOffset | Q-OffsetRange |

}

In one alternative (Alt 1), in order for the network to inform an advanced UE of the cell type of neighbor cells for which the UE performs RSRP measurement, CellsToAddMod may be modified to include the cell type of each neighbor cell.

In one example, the following change is made according to the current alternative:

CellsToAddMod-r12 ::= SEQUENCE {

| | |
|---|---|
| cellIndex | INTEGER (1..maxCellMeas), |
| physCellId | PhysCellId, |
| cellIndividualOffset | Q-OffsetRange |
| NCTIndicator | BOOLEAN |

}

Here, NCTIndicator is TRUE if the cell is NCT or convertible-type, FALSE if the cell is BCT.

In another example, the following change can be made according to the current alternative:

CellsToAddMod-r12 ::= SEQUENCE {

| | |
|---|---|
| cellIndex | INTEGER (1..maxCellMeas), |
| physCellId | PhysCellId, |
| cellIndividualOffset | Q-OffsetRange |
| cellType | ENUMERATED{backwardCompatible,NCT} |

}

Here, cellType is NCT if the cell is NCT or convertible-type, backwardCompatible if the cell is BCT.

In another alternative (Alt 2), the type of the neighbor cell is implicitly indicated by the time location of PSS/SSS. When the UE detects PSS/SSS according to the legacy specification (or according to FIG. 3), the UE determines that the cell is BCT. On the other hand, when the UE detects PSS/SSS in a different pair of OFDM symbols than the pair of OFDM symbols allocated for PSS/SSS in the legacy specification (or according to FIG. 3), the UE determines the cell is NCT.

Method Y:

When the cell (or subframe) type is NCT, the advanced UE should read PDSCH symbols from the first OFDM symbol (OFDM symbol 0 in the first time slot) within the assigned Physical Resource Blocks (PRBs); furthermore, in those subframes where TRS is not transmitted, the advanced UE does not apply rate matching around CRS. On the other hand, when the cell (or subframe) type is BCT, the advanced UE should read PDSCH symbols from the configured OFDM symbol number within the assigned PRBs with rate matching around the PDCCH region and CRS REs (according to the MBSFN subframe configuration).

Here, the configured OFDM symbol number is indicated to the advanced UE by at least one of the following alternatives:
The advanced UE decodes PCFICH, which indicates the starting OFDM symbol number for the PDSCH.
The advanced UE is signaled by an RRC configuration which indicates the starting OFDM symbol number for the PDSCH.
   When an advanced UE is configured with Transmission Mode 10 (TM10), the advanced UE receives a 2-bit field indicating rate matching pattern. Considering the operation in the convertible-type cell, it makes sense that the advanced UE's behavior changes depending upon the subframe type. When the subframe-type is BCT, the UE follows Rel-11 specification for the rate matching (i.e., PDSCH symbols are rate matched around PDCCH region); on the other hand, when the subframe-type is NCT, the UE reads the PDSCH symbols from the first OFDM symbol in the first time slot; furthermore, in those subframes where TRS is not transmitted, the advanced UE does not apply rate matching around CRS.

Method Z:

Depending on the cell (or subframe) type, the advanced UE calculate CQI differently. In BCT subframes (or cells), when deriving the CQI index, some of the UE assumptions for the CSI resource are:
the first 3 OFDM symbols are occupied by control signaling;
if CSI-RS is used for channel measurements, the ratio of PDSCH Energy Per Resource Element (EPRE) to Channel State Information Reference Signal (CSI-RS) EPRE is as given in Section 7.2.5 of TS36.213; and
for Transmission Mode 9 (TM9) CSI reporting, CRS REs are the same as those in non-MBSFN subframes.

In NCT subframes (or cells), in order to facilitate more accurate CQI derivation for the NCT, the UE assumptions above for the CSI reference resource are modified for the NCT subframes (cells) as follows:
Zero OFDM symbols are occupied by control signaling (since conventional PDSCH is not transmitted).
CP length is that of the non-MBSFN subframes.
Redundancy Version 0 is employed.
If CSI-RS is used for channel measurements (which may be always the case), the ratio of PDSCH EPRE to CSI-RS EPRE is given by P_{C}. P_{C} is the assumed ratio of PDSCH EPRE to CSI-RS EPRE when UE derives CSI feedback and takes values in the range of [−8, 15] dB with 1 dB step size, for all the OFDM symbols in the subframe.
If Transmission Mode 8 (TM8) is supported, for CSI reporting, no CRS REs are assumed in the CSI reference resource (since no CRS may exist in the extension carrier).
If TM9 is supported, for CSI reporting, no CRS REs assumed in the CSI reference resource (since no CRS may exist in the extension carrier).
If the UE is configured for Precoding Matrix Indicator/Rank Indicator (PMI/RI) reporting, the UE-specific reference signal overhead is consistent with the most recent reported rank; and PDSCH signals on antenna ports {7 . . . 6+v} for v layers would result in signals equivalent to corresponding symbols transmitted on antenna ports {15 . . . 14+P}, as given

$$[ \begin{matrix}{y}^{( 15 )} ( i ) \\ ⋮ \\ {y}^{( 14 + P )} ( i )\end{matrix} ] = W ( i ) [ \begin{matrix}{x}^{( 0 )} ( i ) \\ ⋮ \\ {x}^{( υ - 1 )} ( i )\end{matrix} ] ,$$

where x(i)=[x⁽⁰⁾(i) . . . x^{(υ-1)}(i)]^{T} is a vector of symbols from the layer mapping in section 6.3.3.2 of TS 36.211, Pε{1, 2, 4, 8} is the number of CSI-RS ports configured, and if only one CSI-RS port is configured, W(i) is 1 but otherwise W(i) is the precoding matrix corresponding to the reported PMI applicable to x(i). The corresponding PDSCH signals transmitted on antenna ports {15 . . . 14+P} would have a ratio of EPRE to CSI-RS EPRE equal to the ratio given in section 7.2.5 of TS 36.211.
The PDSCH transmission scheme assumed for CSI reference resource for TM8 or TM9 is given in Table 2 of TS 36.211. The basic DM-RS TS for CSI-feedback can be:
   Option 1: Fixed and predefined, e.g. single antenna port transmission scheme using DM RS port 7, or Transmit diversity scheme based on DM RS port(s), e.g. port 7 and port 8.
   Option 2: configurable by higher layer signaling (see Table 3).
   Option 3: Same as the basic DM-RS TS configured/defined for PDSCH demodulation as described in Embodiment 1 (see Table 4).
When the basic DM-RS TS for CSI feedback is Basic DM-RS TS 1, i.e., the single-antenna port transmission scheme using DM-RS port 7, the CSI is derived as if only one CSI-RS port is configured, relying only on antenna port 15. In other words, PDSCH signals on antenna ports {7} for 1 layer would result in signals equivalent to corresponding symbols transmitted on antenna ports {15}, as given by y⁽¹⁵⁾(i)=x⁽⁰⁾(i), where x⁽⁰⁾(i) is a symbol from the layer mapping in section 6.3.3.2 of TS 36.211.
When the basic DM-RS TS for CSI feedback is Basic DM-RS TS 2, i.e., the transmit diversity transmission scheme using DM-RS ports 7 and 8, the CSI is derived under the following two assumptions:
   Channels estimated on CSI-RS port 15 are the same as channels estimated on DM-RS port 7; and
   Channels estimated on CSI-RS port 16 are the same as channels estimated on DM-RS port 8.
In other words, PDSCH signals on antenna ports {7,8} for 2 layers would result in signals equivalent to corresponding symbols transmitted on antenna ports {15,16}, as given by

$$[ \begin{matrix}{y}^{( 15 )} ( 2 i ) \\ {y}^{( 16 )} ( 2 i ) \\ {y}^{( 15 )} ( 2 i + 1 ) \\ {y}^{( 16 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ] ,$$

where x(i)=[x⁽⁰⁾(i) x⁽¹⁾(i)]^{T} is a vector of symbols from the layer mapping in section 6.3.3.3 of TS 36.211.

Note that this embodiment also extends to other TMs supported in the extension carrier.

TABLE II
PDSCH transmission scheme assumed for CSI reference resource

| Transmission Mode | Transmission scheme of PDSCH |
|---|---|
| 8 | If the UE is configured without PMI/RI |
| | reporting: basic DM-RS TS for CSI feedback |
| | If the US is configured with PMI/RI |
| | reporting: closed-loop spatial multiplexing |
| 9 | If the UE is configured without PMI/RI |
| | reporting: basic DM-RS TS for CSI feedback |
| | If the US is configured with PMI/RI |
| | reporting: if the number of CSI-RS ports is |
| | one, single-antenna port, port 7; otherwise |
| | up to 8 layer transmission, ports 7-14 (see |
| | subclause 7.1.5B) |

TABLE III
Basic DM-RS TS for CSI feedback configurable
by higher layer signaling

| Higher layer | |
|---|---|
| signaling | Basic DM-RS TS for CSI feedback |
| 0 | Basic DM-RS TS 1, e.g. single antenna port |
| | transmission scheme using DM RS port 7 |
| 1 | Basic DM-RS TS 2, e.g. transmit diversity |
| | scheme based on DM RS port(s), e.g. port 7 |
| | and port 8 |

TABLE IV
Basic DM-RS TS for CSI feedback same
as that used for PDSCH demodulation

| Basic DM-RS TS for PDSCH | |
|---|---|
| demodulation | Basic DM-RS TS for CSI feedback |
| Basic DM-RS TS 1 | Basic DM-RS TS 1 |
| Basic DM-RS TS 2 | Basic DM-RS TS 2 |

In Rel-10 LTE, for TM8 and TM9, the transmission scheme of PDSCH uses DM RS ports (7-8 for TM8 and 7-14 for TM9) when the PDCCH uses downlink control information (DCI) format 2B and 2C, respectively. For DCI format 1A, the transmission scheme in Rel-10 may use CRS ports (see Table 7.1-5 in TS 36.213). If TM8 and/or TM9 are supported in the extension carrier, in order to support PDSCH transmission using DCI format 1A in the NCT cell (or subframe), for TM8 and/or 9, a transmission scheme that uses DM RS ports is always used for PDSCH transmission using DCI format 1A, hereafter referred to as the basic DM-RS transmission scheme (TS). Note that this proposal extends to any transmission modes that are supported in the NCT cell (or subframe).

Alternatives of the Basic DM-RS TS

Alternatives of the basic DM-RS TS are as follows:
Alternative 1 (Basic DM-RS TS 1): single antenna port transmission scheme using DM RS port 7 is used for PDSCH transmission scheduled using DCI format 1A.
   Since single antenna port transmission scheme using DM RS port 7 is already defined in Rel-10, this option has the advantage that it does not introduce a new transmission scheme.
   One example for the single antenna port transmission scheme is precoding cycling for each resource blocks where, e.g., the precoder applied (on DM RS port and the data) can be different for different resource blocks (in frequency). In this case, the UE may not assume PRB (physical resource block) bundling when receiving the PDSCH using the basic DM-RS TS, regardless of whether PMI/RI feedback is configured (relevant for transmission mode 9 as there is no support for PRB bundling for transmission mode 8). In other words, in this example, if the UE is configured with transmission mode 9, the condition for UE to assume PRB bundling is applied as described in Sec 7.1.6.5 of Sec 36.213 is modified as follows: The UE may assume that precoding granularity is multiple resource blocks in the frequency domain when PMI/RI feedback is configured and if the transmission scheme is not Basic DM-RS TS 1, which can be implied by the type of DCI format used for PDSCH scheduling, e.g. DCI format 1A can indicate that the transmission scheme is Basic DM-RS TS 1.
   In another example the single antenna port transmission scheme is precoding cycling for each resource element (RE). In this case, precoding may not be applied on the DM RS and is applied only on the data. The precoding applied to the data for every RE can be predefined and known at both the eNB and the UE.
Alternative 2 (Basic DM-RS TS 2): Transmit diversity scheme based on DM RS port(s), e.g. port 7 and port 8.
   This alternative has the advantage that it may provide better performance and transmission reliability than Alternative 1.
   One example of the DM-RS based transmit diversity scheme is Space Frequency Block Coding (SFBC).

FIGS. 8A, 8B and 8C illustrate network configuration snapshots for the small cells in order to achieve energy saving and to adapt the operation based upon the UE-type population. UEs maintain basic mobility on a Pcell that is BCT, and receive/transmit data mainly on the Scell that is convertible-type (CT). FIG. 8A depicts a network configuration during the busy hours, where the network turns on all the small cell eNBs S1, S2, S3 and S4 to serve the large UE population. The small cell eNBs can be configured as CT, so that some legacy UEs can be served in the small cells as well as the advanced UEs. FIG. 8B depicts the network configuration during the off-peak hours, where the network turns off some small cells S1, S3 for energy saving. The coverage of each remaining active small cell eNB S2, S4 can be extended as inter-cell interference is reduced by turning off the other small cells. Finally, FIG. 8C depicts a network configuration of the CT small cells during the off-peak hours, where the network configures one Scell S2 to be BCT and another Scell S4 to be NCT, depending on the UE population that each small cell covers. As the small cell S4 serves only the advanced UEs, S4 is operating as NCT; on the other hand, as the small cell S2 serves both the advanced and the legacy UEs, S2 is operating as BCT at least in a subset of subframes.

The network may make decision to convert the network configuration from FIG. 8A to FIG. 8B based upon the network detecting that the number of UEs connected to each cell is smaller than a threshold. When converting to the network configuration of FIG. 8B from FIG. 8A, the coverage of each turned-on cell (i.e., S2 and S4) may increase as inter-cell interference decreases. This is true especially when the cells S2 and S4 do not change transmission power according to the network configuration.

On the other hand, the network may make a decision to convert the network configuration from FIG. 8B to FIG. 8A when the network detects that the number of UEs connected to each cell is larger than a threshold.

When a UE moves from a coverage area of small cell S1 to a coverage area of small cell S2 in FIG. 8A, the network may re-configure the Scell for the UE, from S1 to S2, so that the UE receives/transmits data mainly to S2.

Beyond LTE-Adv Air Standards

3GPP TS 36.211 [REF1] Sec. 6.10.3.2 (“Mapping to resource elements”) describes the following for UE-specific RS in 3GPP Rel-11 specifications:

For antenna ports p=7, p=8 or p=7, 8 . . . υ+6, in a physical resource block (PRB) with a frequency-domain index assigned for the corresponding PDSCH transmission, a part of the reference signal sequence r(m) shall be mapped to complex-valued modulation symbols a_{k,l}^{(p)} in a subframe according to

### Normal Cyclic Prefix:

$${a}_{k , l}^{( p )} = {w}_{p} ( {l}^{′} ) \cdot r ( 3 \cdot {l}^{′} \cdot {N}_{RB}^{max , DL} + 3 \cdot {n}_{PRB} + {m}^{′} )$$

$$where$$

$${w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 7 , 8 , 11 , 13 \} \\ 0 & p ∈ \{ 9 , 10 , 12 , 14 \}\end{matrix} \\ l = \{ \begin{matrix}{l}^{′} mod 2 + 2 & if in a special subframe with configurations 3 , 4 , 8 or 9 ( see Table 4.2 - 1 ) \\ {l}^{′} mod 2 + 2 + 3 ⌊ {l}^{′} / 2 ⌋ & if in a special subframe with configurations 1 , 2 , 6 or 7 ( see Table 4.2 - 1 ) \\ {l}^{′} mod 2 + 5 & if not in a special subframe\end{matrix} \\ {l}^{′} = \{ \begin{matrix}0 , 1 , 2 , 3 & if {n}_{s} mod 2 = 0 in a special subframe with configurations 1 , 2 , 6 or 7 ( see Table 4.2 - 1 ) \\ 0 , 1 & if {n}_{s} mod 2 = 0 in a special subframe with configurations 1 , 2 , 6 or 7 ( see Table 4.2 - 1 ) \\ 2 , 3 & if {n}_{s} mod 2 = 1 and not in a special subframe\end{matrix} \\ {m}^{′} = 0 , 1 , 2$$

The sequence w̅ₚ(i) is given by TABLE V below:

TABLE V
The sequence w̅ₚ(i) for normal cyclic prefix

| Antenna port p | [ w̅ₚ(0) w̅ₚ(1) w̅ₚ(2) w̅ₚ(3)] |
|---|---|
| 1 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

Resource elements (k,l) used for transmission of UE-specific reference signals to one UE on any of the antenna ports in the set S, where S={7, 8, 11, 13} or S={9, 10, 12, 14} shall
not be used for transmission of PDSCH on any antenna port in the same slot, and
not be used for UE-specific reference signals to the same UE on any antenna port other than those in in the same slot.
   FIG. 9 illustrates the resource elements used for UE-specific reference signals for normal cyclic prefix for antenna ports 7, 8, 9 and 10.

3GPP TS 36.212 [REF2] Section 5.3.3.1.5C (“Format 2C”) describes DCI format 2C as in the following:

The following information is transmitted by means of the DCI format 2C:
Carrier indicator—0 or 3 bits. The field is present according to the definitions in [REF3].
Resource allocation header (resource allocation type 0/type 1)−1 bit as defined in section 7.1.6 of [REF3]
If downlink bandwidth is less than or equal to 10 PRBs, there is no resource allocation header and resource allocation type 0 is assumed.
Resource block assignment:
   For resource allocation type 0 as defined in section 7.1.6.1 of [REF3]

$$⌈ {N}_{RB}^{DL} / P ⌉$$

bits provide the resource allocation
For resource allocation type 1 as defined in section 7.1.6.2 of [REF3]
[log₂(P)] bits of this field are used as a header specific to this resource allocation type to indicate the selected resource blocks subset
1 bit indicates a shift of the resource allocation span

$$( ⌈ {N}_{RB}^{DL} / P ⌉ ⌈ {log}_{2} ⌉ ( P ) - 1 )$$

bits provide the resource allocation
where the value of P depends on the number of DL resource blocks as indicated in section [7.1.6.1] of [REF3]
TPC command for PUCCH—2 bits as defined in section 5.1.2.1 of [REF3]
Downlink Assignment Index (this field is present in TDD for all the uplink-downlink configurations and only applies to TDD operation with uplink-downlink configuration 1-6. This field is not present in FDD)-2 bits
HARQ process number—3 bits (FDD), 4 bits (TDD)
Antenna port(s), scrambling identity and number of layers—3 bits as specified in TABLE VI where n_{SCID} is the scrambling identity for antenna ports 7 and 8 defined in section 6.10.3.1 of [REF1]
SRS request—[0-1] bit. This field can only be present for TDD and if present is defined in section 8.2 of [REF3]

In addition, for transport block 1:
Modulation and coding scheme—5 bits as defined in section 7.1.7 of [REF3]
New data indicator—1 bit
Redundancy version—2 bits

In addition, for transport block 2:
Modulation and coding scheme—5 bits as defined in section 7.1.7 of [REF3]
New data indicator—1 bit
Redundancy version—2 bits
HARQ-ACK resource offset (this field is present when this format is carried by EPDCCH. This field is not present when this format is carried by PDCCH)—2 bits as defined in section 10.1 of [REF3]

If both transport blocks are enabled; transport block 1 is mapped to codeword 0; and transport block 2 is mapped to codeword 1.

In case one of the transport blocks is disabled, the transport block to codeword mapping is specified according to Table 5.3.3.1.5 2. For the single enabled codeword, Value=4, 5, 6 in TABLE VI below are only supported for retransmission of the corresponding transport block if that transport block has previously been transmitted using two, three or four layers, respectively.

If the number of information bits in format 2C carried by PDCCH belongs to one of the sizes in Table 5.3.3.1.2-1, one zero bit shall be appended to format 2C.

TABLE VI
Antenna port(s), scrambling identity
and number of layers indication

| | |
|---|---|
| One Codeword: | Two Codewords: |
| Codeword 0 enabled, | Codeword 0 enabled, |
| Codeword 1 disabled | Codeword 1 enabled |

| Value | Message | Value | Message |
|---|---|---|---|
| 0 | 1 layer, port 7, n_{SCID} = 0 | 0 | 2 layers, ports 7-8, |
| | | | n_{SCID} = 0 |
| 1 | 1 layer, port 7, n_{SCID} = 1 | 1 | 2 layers, ports 7-8, |
| | | | n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-14 |

5.3.3.1.5D Format 2D

The following information is transmitted by means of the DCI format 2D:

. . . (Same field descriptions as in Format 2C until redundancy version for transport block 2)
PDSCH RE Mapping and Quasi-Co-Location Indicator—2 bits as defined in sections 7.1.9 and 7.1.10 of [REF3]
HARQ-ACK resource offset (this field is present when this format is carried by EPDCCH. This field is not present when this format is carried by PDCCH)-2 bits as defined in section 10.1 of [REF3]

If both transport blocks are enabled; transport block 1 is mapped to codeword 0; and transport block 2 is mapped to codeword 1.

In case one of the transport blocks is disabled; the transport block to codeword mapping is specified according to Table 5.3.3.1.5 2. For the single enabled codeword, Value=4, 5, 6 in Table 2 are only supported for retransmission of the corresponding transport block if that transport block has previously been transmitted using two, three or four layers, respectively.

If the number of information bits in format 2D carried by PDCCH belongs to one of the sizes in Table 5.3.3.1.2-1, one zero bit shall be appended to format 2D.

[REF3] describes PQI field and quasi co-location as in the following:

7.1.9 PDSCH resource mapping parameters

A UE configured in transmission mode 10 for a given serving cell can be configured with up to 4 parameter sets by higher layer signaling to decode PDSCH according to a detected PDCCH/EPDCCH with DCI format 2D intended for the UE and the given serving cell. The UE shall use the parameter set according to the value of the ‘PDSCH RE Mapping and Quasi-Co-Location indicator’ field (mapping defined in TABLE VII below) in the detected PDCCH/EPDCCH with DCI format 2D for determining the PDSCH RE mapping (defined in Section 6.3.5 of [REF1]) and PDSCH antenna port quasi co-location (defined in Section 7.1.10). For PDSCH without a corresponding PDCCH, the UE shall use the parameter set indicated in the PDCCH/EPDCCH with DCI format 2D corresponding to the associated SPS activation for determining the PDSCH RE mapping (defined in Section 6.3.5 of [REF1]) and PDSCH antenna port quasi co-location (defined in Section 7.1.10).

TABLE VII
Antenna port(s), scrambling identity
and number of layers indication

| Value of ‘PDSCH RE | |
|---|---|
| Mapping and Quasi-Co- | |
| Location Indicator’ field | Description |
| ‘00’ | Parameter set 1 configured by higher |
| | layers |
| ‘01’ | Parameter set 2 configured by higher |
| | layers |
| ‘10’ | Parameter set 3 configured by higher |
| | layers |
| ‘11’ | Parameter set 4 configured by higher |
| | layers |

The following parameters for determining PDSCH RE mapping and PDSCH antenna port quasi co-location are configured via higher layer signaling for each parameter set:
‘Number of CRS antenna ports for PDSCH RE mapping’.
‘CRS frequency shift for PDSCH RE mapping’.
‘MBSFN subframe configuration for PDSCH RE mapping’.
‘Zero-power CSI-RS resource configuration for PDSCH RE mapping’.
‘PDSCH starting position for PDSCH RE mapping’.
‘CSI-RS resource configuration identity for PDSCH RE mapping’.
   A UE configured in transmission mode 10 for a given serving cell can be configured with a parameter set selected from the four parameter sets in TABLE VII by higher layer signaling for determining the PDSCH RE mapping (defined in Section 6.3.5 of [REF1]) and PDSCH antenna port quasi co-location (defined in Section 7.1.10) to decode PDSCH according to a detected PDCCH/EPDCCH with DCI format 1A intended for the UE and the given serving cell. The UE shall use the configured parameter set, determining the PDSCH RE mapping (defined in Section 6.3.5 of [REF1]) and PDSCH antenna port quasi co-location (defined in Section 7.1.10) for decoding PDSCH corresponding to detected PDCCH/EPDCCH with DCI format 1A and PDSCH without a corresponding PDCCH associated with SPS activation indicated in PDCCH/EPDCCH with DCI format 1A.

7.1.10 Antenna Ports Quasi Co-Location for PDSCH

A UE configured in transmission mode 1-10 may assume the antenna ports 0-3 of a serving cell are quasi co-located (as defined in [REF1]) with respect to delay spread, Doppler spread, Doppler shift, average gain, and average delay.

A UE configured in transmission mode 8-10 may assume the antenna ports 7-14 of a serving cell are quasi co-located (as defined in [REF1]) for a given subframe with respect to delay spread, Doppler spread, Doppler shift, average gain, and average delay.

A UE configured in transmission mode 1-9 may assume the antenna ports 0-3, 5, 7-22 of a serving cell are quasi co-located (as defined in [REF1]) with respect to Doppler shift, Doppler spread, average delay, and delay spread.

A UE configured in transmission mode 10 is configured with one of two quasi co-location types by higher layer signaling to decode PDSCH according to transmission scheme associated with antenna ports 7-14:
Type A: The UE may assume the antenna ports 0-3, 7-22 of a serving cell are quasi co-located (as defined in [REF1]) with respect to delay spread, Doppler spread, Doppler shift, and average delay
Type B: The UE may assume the antenna ports 15-22 corresponding to the CSI-RS resource configuration identified by ‘CSI-RS resource configuration identity for PDSCH RE mapping’ in Section 7.1.9 and the antenna ports 7-14 associated with the PDSCH are quasi co-located (as defined in [REF1]) with respect to Doppler shift, Doppler spread, average delay, and delay spread.

In [REF1], the following paragraph is captured to define the quasi co-location:

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, and average delay.

In [REF1], the following is captured for ePDCCH DMRS:

6.10.3A Demodulation Reference Signals Associated with EPDCCH

The demodulation reference signal associated with EPDCCH
is transmitted on the same antenna port pε{107,108,109,110} as the associated EPDCCH physical resource;
is present and is a valid reference for EPDCCH demodulation only if the EPDCCH transmission is associated with the corresponding antenna port; and
is transmitted only on the physical resource blocks upon which the corresponding EPDCCH is mapped.

A demodulation reference signal associated with EPDCCH is not transmitted in resource elements (k,l) in which one of the physical channels or physical signals other than the demodulation reference signals defined in 6.1 are transmitted using resource elements with the same index pair (k,l) regardless of their antenna port p.

6.10.3A.1 Sequence Generation

For any of the antenna ports pε{107,108,109,110}, the reference-signal sequence r(m) is defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 1 , 2 {N}_{RB}^{max , DL} - 1 & normal cyclic prefix \\ 0 , 1 , … , 16 {N}_{RB}^{max , DL} - 1 & extended cylic prefix .\end{matrix}$$

The pseudo-random sequence c(i) is defined in Section 7.2. The pseudo-random sequence generator shall be initialized with

c(i)=(└ⁿ^{ₛ}/2┘+1)·(2n_{ID,i}^{EPDCCH}+1)·2¹⁶+n_{SCID}^{EPDCCH}

at the start of each subframe where n_{SCID}^{EPDCCH}=2 and 2_{ID,i}^{EPDCCH} is configured by higher layers. The EPDCCH set to which the EPDCCH associated with the demodulation reference signal belong is denoted iε{0,1}.

6.10.3A.2 Mapping to Resource Elements

For the antenna port pε{107,108,109,110} in a physical resource block n_{PRB} assigned for the associated EPDCCH, a part of the reference signal sequence r(m) shall be mapped to complex-valued modulation symbols a_{k,l}^{(p)} in a subframe according to Normal cyclic prefix:

$${a}_{k , l}^{( p )} = {w}_{p} ( {l}^{′} ) \cdot r ( 3 \cdot {l}^{′} \cdot {N}_{RB}^{max , DL} + 3 \cdot {n}_{PRB} + {m}^{′} )$$

$$where$$

$${w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 107 , 108 \} \\ 0 & p ∈ \{ 109 , 110 \}\end{matrix} \\ l = \{ \begin{matrix}{l}^{′} mod 2 + 2 & if in a special subframe with configurations 3 , 4 , 8 or 9 ( see Table 4.2 - 1 ) \\ {l}^{′} mod 2 + 2 + 3 ⌊ {l}^{′} / 2 ⌋ & if in a special subframe with configurations 1 , 2 , 6 or 7 ( see Table 4.2 - 1 ) \\ {l}^{′} mod 2 + 5 & if not in a special subframe\end{matrix} \\ {l}^{′} = \{ \begin{matrix}0 , 1 , 2 , 3 & if {n}_{s} mod 2 = 0 in a special subframe with configurations 1 , 2 , 6 or 7 ( see Table 4.2 - 1 ) \\ 0 , 1 & if {n}_{s} mod 2 = 0 in a special subframe with configurations 1 , 2 , 6 or 7 ( see Table 4.2 - 1 ) \\ 2 , 3 & if {n}_{s} mod 2 = 1 and not in a special subframe\end{matrix} \\ {m}^{′} = 0 , 1 , 2$$

The sequence w̅ₚ(i) is given by TABLE VIII below:

TABLE VIII
The sequence w̅ₚ(i) for normal cyclic prefix

| Antenna port p | [ w̅ₚ(0) w̅ₚ(1) w̅ₚ(2) w̅ₚ(3)] |
|---|---|
| 107 | [+1 +1 +1 +1] |
| 108 | [+1 −1 +1 −1] |
| 109 | [+1 +1 +1 +1] |
| 110 | [+1 −1 +1 −1] |

Resource elements (k,l) used for transmission of demodulation reference signals to one UE on any of the antenna ports in the set S, where S={107,108} or S={109,110} shall
not be used for transmission of EPDCCH on any antenna port in the same slot, and
not be used for UE-specific reference signals to the same UE on any antenna port other than those in S in the same slot.

Replacing antenna port numbers 7-10 by 107-110 in FIG. 9 provides an illustration of the resource elements used for demodulation reference signals associated with EPDCCH for normal cyclic prefix.

In TS 36.213 [REF3], the following is captured for the resource mapping parameters for EPDCCH:

9.1.4.3 Resource Mapping Parameters for EPDCCH

For a given serving cell, if the UE is configured via higher layer signalling to receive PDSCH data transmissions according to transmission mode 10, and if the UE is configured to monitor EPDCCH, for each EPDCCH-PRB-set, the UE shall use the parameter set indicated by the higher layer parameter re-MappingQCLConfigListId-r11 for determining the EPDCCH RE mapping (defined in Section 6.8A.5 of [REF1]) and EPDCCH antenna port quasi co-location. The following parameters for determining EPDCCH RE mapping and EPDCCH antenna port quasi co-location are included in the parameter set:
‘Number of CRS antenna ports for PDSCH RE mapping’.
‘CRS frequency shift for PDSCH RE mapping’.
‘MBSFN subframe configuration for PDSCH RE mapping’.
‘Zero-power CSI-RS resource configuration(s) for PDSCH RE mapping’.
‘PDSCH starting position for PDSCH RE mapping’.
‘CSI-RS resource configuration identity for PDSCH RE mapping’.

In 36.213 [REF3], the following is captured for MCS index:

7.1.7.1 Modulation Order Determination

The UE shall use Qₘ=2 if the DCI cyclic redundancy check (CRC) is scrambled by Paging Radio Network Temporary Identifier (P-RNTI), Random Access Radio Network Temporary Identifier (RA-RNTI), or System Information Radio Network Temporary Identifier (SI-RNTI); otherwise, the UE shall use the modulation and coding scheme (MCS) index I_{MCS} and Table 7.1.7.1-1 (TABLE IX below) to determine the modulation order (Qₘ) used in the physical downlink shared channel for a given transport block size index) (I_{TBS}).

TABLE IX
Modulation and TBS index table for PDSCH

| MCS Index (I_{MCS}) | Modulation Order (Qₘ) | TBS Index |
|---|---|---|
| 0 | 2 | 0 |
| 1 | 2 | 1 |
| 2 | 2 | 2 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 4 | 9 |
| 11 | 4 | 10 |
| 12 | 4 | 11 |
| 13 | 4 | 12 |
| 14 | 4 | 13 |
| 15 | 4 | 14 |
| 16 | 4 | 15 |
| 17 | 6 | 15 |
| 18 | 6 | 16 |
| 19 | 6 | 17 |
| 20 | 6 | 18 |
| 21 | 6 | 19 |
| 22 | 6 | 20 |
| 23 | 6 | 21 |
| 24 | 6 | 22 |
| 25 | 6 | 23 |
| 26 | 6 | 24 |
| 27 | 6 | 25 |
| 28 | 6 | 26 |
| 29 | 2 | Reserved |
| 30 | 4 | |
| 31 | 6 | |

FIG. 9 and TABLE V respectively describe UE-RS (or DMRS) patterns and orthogonal cover codes (OCCs) for APs 7 to 14 in Rel-10 3GPP LTE standards.

TABLE VI explains a field in DCI formats 2C and 2D, which indicates antenna port(s), scrambling identity (SCID) and number of layers. According to TABLE VI, the interpretation of the 3-bit field is different depending upon how many codewords (CWs) are enabled. When one CW is enabled, the 3-bit field can indicate one of 7 possibilities comprising one-layer, two-layer, three-layer and four-layer transmissions. Among the 7 states, four of those states indicate one-layer transmissions, on (AP 7, SCID 0), (AP 7, SCID 1), (AP 8, SCID 0) and (AP 8, SCID 1). The other three states indicate two-layer, three-layer and four-layer transmissions that are used only for retransmission of a single CW, out of two initially transmitted CWs in a previous subframe. When two CWs are enabled, the 3-bit field can indicate one of 8 possibilities comprising 2-8 layer transmissions. Among the 8 states, two of those states indicate two-layer transmissions, on (AP 7-8, SCID 0) and (AP 7-8, SCID 1). The other six states indicate 3-8 layer transmissions.

The 3GPP LTE Rel-10 supports multi-user multiple input, multiple output (MU-MIMO) transmissions. Up to four layers can be multiplexed in a MU-MIMO transmission, relying on APs 7-8 and SCIDs 0-1. To multiplex 4 rank-1 UEs in the same PRB, eNB may configure (AP 7, SCID 0), (AP 7, SCID 1), (AP 8, SCID 0) and (AP 8, SCID 1) to the 4 UEs, relying on the indication mechanism of TABLE VI. A UE configured with (AP 7, SCID 0) may see intra-cell interference on the DMRS REs, corresponding to (AP 7, SCID 1), (AP 8, SCID 0) and (AP 8, SCID 1). The interference caused by DMRS of (AP 8, SCID 0) is likely to be orthogonal to the DMRS of (AP 7, SCID 0) thanks to the OCCs used for APs 7 and 8. However, the interference caused by DMRS of (AP 7, SCID 1) and (AP 8, SCID 1) is not orthogonal because of the different scrambling sequence generated by SCID 1.

[REF5] introduces a field jointly indicating the number of layers (antenna ports), the pilot resource allocation (AP numbers), and SU/MU MIMO. However, [REF5] did not disclose which codepoints to use in a DCI to indicate the information.

In addition, SU-MIMO and MU-MIMO are non-transparently indicated here (for example, state 0 is identical to state 8 except for MU-MIMO and SU-MIMO difference), which reduces scheduling flexibility.

Considering that the non-orthogonal interference could degrade performance much worse than the orthogonal interference, although Rel-10 support MU-MIMO multiplexing of up to 4 layers it may not be practically feasible for a UE to deal with the non-orthogonal interference in case the UE is co-scheduled with other UEs configured with the a scrambling ID.

To better deal with multi-user interference in DMRS channel estimation, [REF5] proposed to apply length-4 Walsh cover to the 4 REs on the same subcarrier, and support MU-MIMO multiplexing of up to 4 layers with corresponding 4 orthogonal DMRS. As seen in FIG. 9, the 4 DMRS REs on the same subcarrier are partitioned into two groups of two time-consecutive REs, and the two groups are separated by a few OFDM symbols. Because of this time separation of the two groups, the DMRS orthogonality when four UEs are co-scheduled may be broken, especially in the case some UEs are moving in high-speed. However, when all the four UEs are low speed, the four DMRS REs are more likely orthogonal, and the length-4 Walsh cover can be considered when only low speed UEs are considered for MU-MIMO multiplexing.

Similarly, for SU-MIMO of rank 3 and rank 4, when the SU-MIMO UE is moving in low speed, length-4 Walsh covers can be considered for keeping DMRS overhead low while at the same time achieving the orthogonal DMRS for the 3 or 4 layers.

It may be observed that the benefits of applying length-4 Walsh covers on the 4 DMRS REs on the same subcarrier out of the set of 12 DMRS REs for AP 7 are:
Better MU-MIMO DMRS channel estimation performance thanks to orthogonal multiplexing of MU-MIMO DMRS, when the MU-MIMO UEs have low mobility.
Reduced DMRS overhead for rank-3 and rank-4 SU-MIMO, when the SU-MIMO UE has low mobility.

This disclosure describes methods for an eNB to indicate information to UEs involved in the SU-MIMO and MU-MIMO transmissions with the 4 orthogonal DMRS on the set of 12 REs for AP 7. According to the current LTE standards specifications (FIG. 9 and TABLE VI), the 4 orthogonal DMRS are associated with AP 7, AP 8, AP 11 and AP 13.

### Embodiment 1

### Enhancement for MU-MIMO

As seen in TABLE VI, the current LTE specifications has a field in DCI formats 2C and 2D to indicate AP number, scrambling ID, and number of layers.

In Rel-11 LTE, a newly introduced parameter, n_{ID}^{DMRS} (or DMRS VCID), replaces N_{ID}^{cell}, or physical cell ID, in the scrambling initialization equation. The value of n_{ID}^{DMRS} can dynamically change, depending upon the value of nSCID, as in the following (Section 6.10.3.1 in [REF1]):

The pseudo-random sequence generator shall be initialised with

cᵢₙᵢₜ=(└ⁿ^{ₛ}/2┘+1)·(2n_{ID}⁽ⁿ^{_{SCID}}⁾+1)·2¹⁶+n_{SCID}

at the start of each subframe.

The quantities n_{ID}⁽ⁱ⁾, i=0,1, are given by
n_{ID}⁽ⁱ⁾=N_{ID}^{cell} if no value for n_{ID}^{DMRS,i} is provided by higher layers or if DCI format 1A, 2B or 2C is used for the DCI associated with the PDSCH transmission, and
n_{ID}⁽ⁱ⁾=n_{ID}^{DMRS,i} otherwise.
   The value of n_{SCID} is zero unless specified otherwise.

However, in the case of allowing four orthogonal DMRS for MU-MIMO, it is not necessary to use n_{SCID} for MU-MIMO.

Hence, in one design of a new signaling table for supporting four orthogonal DMRS for MU-MIMO, it is proposed to exclude n_{SCID}, and replace those values associated with n_{SCID}=1 with entries associated with AP 11 and AP 13 from TABLE VI. When relying on the legacy mechanism of indicating the VOID (i.e., the value of n_{ID}^{DMRS} is indicated as a function of the value of n_{SCID}), one possible side effect of this is that dynamic switching of n_{ID}^{DMRS} cannot be supported.

Alt 1: No Dynamic Switching of VCIDs when Four Orthogonal DMRS is Configured for MU-MIMO

However, this may not necessarily a bad thing when UE distribution and their channels are relatively static, where dynamic point selection does not give much gain. Considering this scenario, a first alternative (Alt 1) is proposed: that for the UE configured with the four orthogonal DMRS for MU-MIMO, a single value of DMRS VOID, n_{ID}^{DMRS}, is configured, and the UE generates scrambling initialization as in the following:

cᵢₙᵢₜ=(└ⁿ^{ₛ}/2┘+1)·(2n_{ID}+1)·2¹⁶

where n_{ID}=N_{ID}^{cell} if no value for n_{ID}^{DMRS} is provided by higher layers or if DCI format 1A, 2B or 2C is used for the DCI associated with the PDSCH transmission, and n_{ID}=n_{ID}^{DMRS} otherwise.

Coupled with Alt 1, one example of the new signaling table design is shown in TABLE X below:

TABLE X
A new signaling table for indicating
number of layers, and antenna port(s)

| | |
|---|---|
| One Codeword: | Two Codewords: |
| Codeword 0 enabled, | Codeword 0 enabled, |
| Codeword 1 disabled | Codeword 1 enabled |

| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7-9 |
| 3 | 1 layer, port 13 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-13 |

When this table is used, when 1 or 2 layer transmission is signaled to a UE, the UE should assume DMRS overhead of 12 REs for PDSCH rate matching, demodulation and CQI estimation; and the UE should assume traffic-to-pilot ratio of 0 dB.

Alt 2: Dynamic Switching of VCIDs

In a second alternative (Alt 2), we propose to introduce a new way to dynamically indicate n_{ID}^{DMRS}, by including or re-interpreting a one-bit field in a new DCI format for scheduling PDSCH coupled with the four orthogonal DMRS.

Two options are considered for this alternative

Alt 2-1: The NDI of disabled TB (a one-bit field) indicates n_{ID}^{DMRS}.

Alt 2-2: A new explicit one-bit field is included in the new DCI format for scheduling PDSCH, to indicate n_{ID}^{DMRS}.

Assuming that the signaled value of the one-bit field either in Alt 2-1 or in Alt 2-2 is X, the scrambling initialization would be done according to the following:

cᵢₙᵢₜ=(└ⁿ^{ₛ}/2┘+1)·(2n_{ID}^{(X)}+1)·2¹⁶+n_{SCID}

where n_{ID}^{(X)}=N_{ID}^{cell} if no value for n_{ID,X}^{DMRS} is provided by higher layers or if DCI format 1A, 2B or 2C is used for the DCI associated with the PDSCH transmission, and n_{ID}^{(X)}=d_{ID,X}^{DMRS} otherwise.

Coupled with Alt 2, number of layers and antenna port(s) can be indicated as in the new signaling table design in TABLE X.

### Embodiment 2

### Enhancement for SU-MIMO

The introduction of length-4 Walsh cover for SU-MIMO is for overhead reduction. For this purpose, it is proposed to replace 3 and 4 layer entries in TABLE VI with new entries associated with the set of DMRS REs for AP 7 and length-4 Walsh covers.

In one example design shown in TABLE XI, three layer entries indicate ports 7, 8 and 11, the DMRS for the three ports of which are multiplexed relying on 3 Walsh covers on the same set of REs (See TABLE V and FIG. 9). Similarly, four layer entries indicate ports 7, 8, 11 and 13.

TABLE XI
A new signaling table for indicating
number of layers, and antenna port(s)

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, |
| | | | n_{SCID} = 0 |
| 1 | 1 layer, port 7, n_{SCID} = 1 | 1 | 2 layers, ports 7-8, |
| | | | n_{SCID} = 1 |
| 2 | 1 layer, port 8, n_{SCID} = 0 | 2 | 3 layers, ports 7, 8, 11 |
| 3 | 1 layer, port 8, n_{SCID} = 1 | 3 | 4 layers, ports 7, 8, 11, |
| | | | 13 |
| 4 | 2 layers, ports 7-8 | 4 | 5 layers, ports 7-11 |
| 5 | 3 layers, ports 7, 8, 11 | 5 | 6 layers, ports 7-12 |
| 6 | 4 layers, ports 7, 8, 11, | 6 | 7 layers, ports 7-13 |
| | 13 | | |
| 7 | Reserved | 7 | 8 layers, ports 7-14 |

When TABLE XI is configured for a UE, and the UE is scheduled to receive on 1, 2, 3, 4 layers, the UE should assume DMRS overhead of 12 REs for PDSCH rate matching, demodulation and CQI estimation; and the UE should assume traffic-to-pilot ratio of 0 dB.

### Embodiment 3

### Enhancement for SU-MIMO and MU-MIMO

A new signaling table can be defined to support length-4 Walsh cover transmissions for MU-MIMO and SU-MIMO with rank 3 and 4, as in TABLE XII below:

TABLE XII
A new signaling table for indicating
number of layers, and antenna port(s)

| | |
|---|---|
| One Codeword: | Two Codewords: |
| Codeword 0 enabled, | Codeword 0 enabled, |
| Codeword 1 disabled | Codeword 1 enabled |

| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7, 8, 11 |
| 3 | 1 layer, port 13 | 3 | 4 layers, ports 7, 8, 11, |
| | | | 13 |
| 4 | 2 layers, ports 7-8 | 4 | 5 layers, ports 7-11 |
| 5 | 3 layers, ports 7, 8, 11 | 5 | 6 layers, ports 7-12 |
| 6 | 4 layers, ports 7, 8, 11, | 6 | 7 layers, ports 7-13 |
| | 13 | | |
| 7 | Reserved | 7 | 8 layers, ports 7-13 |

Example of higher-layer configuration to indicate which table to use:

A New TM

AP_Layer_Config_R12: An explicit one-bit field to indicate which table to use.

PQI may include table index, to facilitate dynamic switching between two tables, i.e. the information on which table to use by the UE is jointly coded with the other existing PQI information.

Benefit 1: (Scheduling flexibility) Use legacy table for MU-MIMO multiplexing with legacy UEs; Use new table for MU-MIMO multiplexing between R12 UEs.

### Embodiment 4

### Configuration Details (TM Definition, CSI-RS, CSI Process, PQI, Etc.)

A new TM, say TM A, can be defined to support the use of a transmission scheme relying on length-4 Walsh covers for SU/MU-MIMO (e.g., transmission schemes associated with Embodiment 1, 2 and 3).

Which table out of two tables, i.e., the legacy table (TABLE VI) and a new table (one of TABLE X, TABLE XI and TABLE XII), should be used for determining number of layers, antenna port(s), and scrambling ID, may be indicated by a configured transmission mode. For example, when TM 9 or 10 is configured for a UE, the UE should use TABLE VI; on the other hand when TM A is configured, the UE should use the new table.

As for CSI estimation associated with a CSI process, the DMRS overhead assumption associated with 3 or 4 layers (rank 3 or rank 4) changes upon which of the two tables is used. Suppose that the last reported rank is 3 or 4. Then, when the legacy table is used, the DMRS overhead is 24 REs; on the other hand, when the new table is used, the DMRS overhead is 12 REs.

A first alternative to configure the DMRS overhead assumption would be to couple the assumption with the configured TM. When a UE is configured with TM A, the UE should assume the new table for the DMRS overhead assumption in the CSI (CQI) derivation for all the configured CSI processes; while when the UE is configured with TM 9 or 10, the UE should assume TABLE VI for the DMRS overhead assumption in the CSI (CQI) derivation for all the configured CSI processes.

A second alternative is that the CSI process information element includes a field to indicate which table to assume to account for the DMRS overhead for rank 3 and rank 4. In one example, the new CSI process is defined as in the following:

| | |
|---|---|
| CSI-Process-r12 ::= | SEQUENCE { |

| | |
|---|---|
| csi-ProcessIdentity-r11 | CSI-ProcessIdentity-r11, |
| csi-RS-IdentityNZP-r11 | CSI-RS-IdentityNZP-r11, |
| csi-IM-Identity-r11 | CSI-IM-Identity-r11, |

| | |
|---|---|
| p-C-AndAntennaInfoDedList-r11 | SEQUENCE (SIZE (1..2)) OF P-C-AndAntennaInfoDed-r11, |

| | | | |
|---|---|---|---|
| cqi-ReportBothPS-r11 | CQI-ReportBothPS-r11 | OPTIONAL, | -- Need OR |
| cqi-ReportPeriodicId-r11 | INTEGER (0..maxCQI-Ext-r11) | OPTIONAL, | -- Need OR |
| cqi-ReportAperiodicPS-r11 | CQI-ReportAperiodicPS-r11 | OPTIONAL, | -- Need OR |

| | |
|---|---|
| cqi-OverheadRank3Rank4 | ENUMERATED {re12, re24} |

}

In another example, the Rel-11 CSI process can be extended as in the following. The new field can be conditioned on the configuration of TM A.

| | |
|---|---|
| CSI-Process-r11 ::= | SEQUENCE { |

| | |
|---|---|
| csi-ProcessIdentity-r11 | CSI-ProcessIdentity-r11, |
| csi-RS-IdentityNZP-r11 | CSI-RS-IdentityNZP-r11, |
| csi-IM-Identity-r11 | CSI-IM-Identity-r11, |

| | |
|---|---|
| p-C-AndAntennaInfoDedList-r11 | SEQUENCE (SIZE (1..2)) OF P-C-AndAntennaInfoDed-r11, |

| | | | |
|---|---|---|---|
| cqi-ReportBothPS-r11 | CQI-ReportBothPS-r11 | OPTIONAL, | -- Need OR |
| cqi-ReportPeriodicId-r11 | INTEGER (0..maxCQI-Ext-r11) | OPTIONAL, | -- Need OR |
| cqi-ReportAperiodicPS-r11 | CQI-ReportAperiodicPS-r11 | OPTIONAL, | -- Need OR |

| ..., | | | |
|---|---|---|---|
| [[cqi-OverheadRank3Rank4 | ENUMERATED {re12, re24} | OPTIONAL | -- Need OR |

]]

}

Here, the state of the field cqi-OverheadRank3Rank4 indicates whether to assume 12 RE overhead (re12) or 24 RE overhead for the configured CSI process when report CQI associated with rank 3 or rank 4 PMI.

In another example, the new CSI process is defined as in the following:

| | |
|---|---|
| CSI-Process-r12 ::= | SEQUENCE { |

| csi-ProcessIdentity-r11 | CSI-ProcessIdentity-r11, | | |
|---|---|---|---|
| ... | | | |
| cqi-ReportAperiodicPS-r11 | CQI-ReportAperiodicPS-r11 | OPTIONAL, | -- Need OR |

| | |
|---|---|
| antennaPortTable | ENUMERATED {tab1, tab5} |

}

Alternatively, the Rel-11 CSI process can also be extended as follows. The new field can be conditioned on the configuration of TM A.

| | |
|---|---|
| CSI-Process-r11 ::= | SEQUENCE { |

| csi-ProcessIdentity-r11 | CSI-ProcessIdentity-r11, | | |
|---|---|---|---|
| ... | | | |
| cqi-ReportAperiodicPS-r11 | CQI-ReportAperiodicPS-r11 | OPTIONAL, | -- Need OR |
| ... | | | |
| [[antennaPortTable | ENUMERATED {tab1, tab5} | OPTIONAL | -- Need OR |

]]

}

Here, the state of the field antennaPortTable indicates whether to use TABLE VI or the new table to take the DMRS overhead into account in deriving CQI associated with rank 3 or rank 4 PMI.

A third alternative is that cqi-OverheadRank3Rank4 or antennaPortTable is included as a field in PDSCH-RE-MappingQCL-Config, as shown below:

| PDSCH-RE-MappingQCL-Config-r12 ::= | | SEQUENCE { |
|---|---|---|
| | pdsch-RE-MappingQCL-ConfigId-r11 | PDSCH-RE-MappingQCL-ConfigId-r11, |
| | optionalSetOfFields-r11 | SEQUENCE { |

| crs-PortsCount-r11 | ENUMERATED {n1, n2, n4, spare1}, | |
|---|---|---|
| crs-FreqShift-r11 | INTEGER (0..5), | |
| mbsfn-SubframeConfig-r11 | MBSFN-SubframeConfig | OPTIONAL, -- Need OR |

| | |
|---|---|
| pdsch-Start-r11 | ENUMERATED {reserved, n1, n2, n3, n4, assigned} |

| } | | |
|---|---|---|
| | | OPTIONAL, -- Need OP |
| csi-RS-IdentityZP-r11 | CSI-RS-IdentityZP-r11, | |
| qcl-CSI-RS-IdentityNZP-r11 | CSI-RS-IdentityNZP-r11 | OPTIONAL, -- Need OR |

| | |
|---|---|
| cqi-OverheadRank3Rank4 | ENUMERATED {re12, re24} |
| ... | |

}

Alternatively,

| PDSCH-RE-MappingQCL-Config-r11 ::= | | SEQUENCE { |
|---|---|---|
| | pdsch-RE-MappingQCL-ConfigId-r11 | PDSCH-RE-MappingQCL-ConfigId-r11, |
| | optionalSetOfFields-r11 | SEQUENCE { |

| crs-PortsCount-r11 | ENUMERATED {n1, n2, n4, spare1}, | |
|---|---|---|
| crs-FreqShift-r11 | INTEGER (0..5), | |
| mbsfn-SubframeConfig-r11 | MBSFN-SubframeConfig | OPTIONAL, -- Need OR |

| | |
|---|---|
| pdsch-Start-r11 | 4ENUMERATED {reserved, n1, n2, n3, n4, assigned} |

| } | | |
|---|---|---|
| | | OPTIONAL, -- Need OP |
| csi-RS-IdentityZP-r11 | CSI-RS-IdentityZP-r11, | |
| qcl-CSI-RS-IdentityNZP-r11 | CSI-RS-IdentityNZP-r11 | OPTIONAL, -- Need OR |

| ..., | | |
|---|---|---|
| [[cqi-OverheadRank3Rank4 | ENUMERATED {re12, re24} | OPTIONAL -- Need OR |

]]

}

| PDSCH-RE-MappingQCL-Config-r12 ::= | | SEQUENCE { | |
|---|---|---|---|
| | pdsch-RE-MappingQCL-ConfigId-r11 | PDSCH-RE-MappingQCL-ConfigId-r11, | |
| | ... | | |
| | qcl-CSI-RS-IdentityNZP-r11 | CSI-RS-IdentityNZP-r11 | OPTIONAL, -- Need OR |

| | |
|---|---|
| antennaPortTable | ENUMERATED {tab1, tab5} |

...

}

Alternatively,

| PDSCH-RE-MappingQCL-Config-r11 ::= | | SEQUENCE { | |
|---|---|---|---|
| | pdsch-RE-MappingQCL-ConfigId-r11 | PDSCH-RE-MappingQCL-ConfigId-r11, | |
| | ... | | |
| | qcl-CSI-RS-IdentityNZP-r11 | CSI-RS-IdentityNZP-r11 | OPTIONAL, -- Need OR |

| ..., | | |
|---|---|---|
| [[antennaPortTable | ENUMERATED {tab1, tab5} | OPTIONAL -- Need OR |

]]

}

It is noted that PDSCH-RE-MappingQCL-Config corresponds to a parameter set in TABLE VII, and hence a UE can be configured with up to four separate PDSCH-RE-MappingQCL-Config information elements. Then, the selection of table can be dynamically indicated by PQI carried as a field in a DL grant (DCI format 2D). One benefit of configuring antennaPortTable field in PDSCH-RE-MappingQCL-Config is better scheduling flexibility. With this, eNB can dynamically change user pairing, either by using legacy table for MU-MIMO multiplexing with legacy UEs, or by using the new table for MU-MIMO multiplexing among R12 UEs.

Precoding for TM A

In TM A, the antenna port allocation is done according to one of TABLE X, TABLE XI and TABLE XII. In that case, the indicated numbers of antenna ports may not be consecutive, especially when 3 or 4 layers are scheduled. To allow for precoding with non-consecutive numbers of antenna ports for TM A, the following change of the current text is proposed. In the proposal, the precoding method is dependent upon the configured TM.

Precoding for Transmission on a Single Antenna Port

For transmission on a single antenna port, precoding is defined by

y^{(p)}(i)=x⁽⁰⁾(i)

where pε{0, 4, 5, 7, 8, 11, 13} is the number of the single antenna port used for transmission of the physical channel and i=0, 1, . . . , M_{symb}^{ap}−1, M_{symb}^{ap}=M_{symb}^{layer}.

Precoding for spatial multiplexing using antenna ports with cell-specific reference signals

Precoding for spatial multiplexing using antenna ports with UE-specific reference signals is only used in combination with layer mapping for spatial multiplexing as described in Section 6.3.3.2 of [REF1].

When TMs 8, 9, 10 are configured, spatial multiplexing using antenna ports with UE-specific reference signals supports up to eight antenna ports and the set of antenna ports used is p=7, 8, . . . , υ+6.

For transmission on v antenna ports, the precoding operation is defined by

$$[ \begin{matrix}{y}^{( 7 )} ( i ) \\ {y}^{( 8 )} ( i ) \\ ⋮ \\ {y}^{( 6 + v )} ( i )\end{matrix} ] = W ( i ) [ \begin{matrix}{x}^{( 0 )} ( i ) \\ {x}^{( 1 )} ( i ) \\ ⋮ \\ {x}^{( υ - 1 )} ( i )\end{matrix} ]$$

where i=0, 1, . . . , M_{symb}^{ap}−1, M_{symb}^{ap}=M_{symb}^{layer}.

When TM A is configured, spatial multiplexing using antenna ports with UE-specific reference signals supports up to eight antenna ports and the set of antenna ports used is p=p₁, . . . , p_{υ}, as indicated in the new AP mapping table (examples of which are shown in TABLE X, TABLE XI and TABLE XII).

For transmission on v antenna ports, the precoding operation is defined by

$$[ \begin{matrix}{y}^{( {p}_{1} )} ( i ) \\ {y}^{( {p}_{2} )} ( i ) \\ ⋮ \\ {y}^{( {p}_{v} )} ( i )\end{matrix} ] = [ \begin{matrix}{x}^{( 0 )} ( i ) \\ {x}^{( 1 )} ( i ) \\ ⋮ \\ {x}^{( v - 1 )} ( i )\end{matrix} ]$$

where i=0, 1, . . . , M_{symb}^{ap}−1, M_{symb}^{ap}=M_{symb}^{layer}.

ePDCCH DMRS

Similarly, the length-4 Walsh covers can be considered for multiplexing four ePDCCH DMRS in the set of DMRS REs for AP 107, for reducing ePDCCH DMRS overhead.

In order to increase system configuration flexibility, whether to use the length-4 Walsh covers or to use the legacy APs should be able to be UE-specifically configured for each ePDCCH set (or EPDCCH-PRB-set) according to a parameter signaled in the RRC layer.

When the length-4 Walsh covers are used for ePDCCH associated with localized transmissions, APs 107, 108, 111 and 113 are used. Here, replacing antenna port numbers 11 and 13 by 111 and 113 in FIG. 9 provides an illustration of the resource elements used for demodulation reference signals associated with EPDCCH for normal cyclic prefix.

When the length-4 Walsh covers are used for ePDCCH associated with distributed transmissions, APs 107 and 108 are used.

For this operation, a field ap-mapping-ePDCCH can be configured in the RRC layer, which is ENUMERATED{ap-107-108-109-110 or ap-107-108-111-113}, where ap-107-108-109-110 implies that antenna ports 107-110 are used for EPDCCH, and ap-107-108-111-113 implies that antenna ports 107, 108, 111, 113 are used for EPDCCH. When ap-107-108-109-110 is configured, the UE should assume that the DMRS overhead is 24 REs, according to the DMRS RE mapping associated with APs 107-110. On the other hand, when ap-107-108-111-113 is configured, the UE should assume that the DMRS overhead is 12 REs, according to the DMRS RE mapping associated with APs 107,108,111 and 113.

In order to allow for a UE to be able to be configured with either of the two different antenna port configurations, it is proposed to include the field of ap-mapping-ePDCCH in the associated parameter set configured by an information element re-MappingQCLConfigListId-r11 conveyed in the RRC layer.

[REF6] shows that demodulation performance of PDSCH relying on a reduced-overhead UE-RS outperforms the performance relying on a legacy UE-RS generated according to Rel-10 3GPP LTE standards, especially for PDSCH with higher MCS and higher rank. Based upon this observation, it may be useful to introduce reduced-overhead UE-RS for small cells where higher SNR can be obtained.

This disclosure describes proposals for introducing reduced-overhead UE-RS for small cells in the 3GPP LTE standards.

Switching Between a Reduced-Overhead DMRS Pattern and the Legacy UE-RS Pattern

In one embodiment (embodiment 1), reduced-overhead UE-RS can be configured to an advanced UE capable of receiving/transmitting signals according to 3GPP LTE standards. For the same rank (or the same number of transmission layers), number of REs per PRB pair used for the reduced-overhead UE-RS is smaller than that of legacy UE-RS REs.

FIG. 10 illustrates mapping of UE-specific reference signals to resource elements of a resource block (with normal cyclic prefix) according to one embodiment of the present disclosure. One example reduced-overhead UE-RS mapping is shown in FIG. 10, where the first four APs for reduced overhead UE-RS are denoted by a, b, c, d. The eight APs for the reduced-overhead UE-RS are denoted by a, b, c, d, e, f, g, and h. A first set of REs used for UE-RS APs a, b are also used for APs e, g. A second set of REs used for UE-RS APs c, d are also used for APs f, h. The Walsh cover applied for each antenna port is captured in TABLE XIII below:

TABLE XIII
The sequence w̅ₚ(i) for normal cyclic prefix

| Antenna port p | [ w̅ₚ(0) w̅ₚ(1) w̅ₚ(2) w̅ₚ(3)] |
|---|---|
| a | [+1 +1 +1 +1] |
| b | [+1 −1 +1 −1] |
| c | [+1 +1 +1 +1] |
| d | [+1 −1 +1 −1] |
| e | [+1 +1 −1 −1] |
| f | [−1 −1 +1 +1] |
| g | [+1 −1 −1 +1] |
| h | [−1 +1 +1 −1] |

In an advanced system supporting the 3GPP LTE standards, a UE can be configured with a new one-bit message conveyed in the higher-layer (e.g., RRC layer), wherein if the new one-bit message is a first state (e.g., 0), the UE is configured to receive PDSCH with the legacy UE-RS and if the new one-bit message is a second state (e.g., 1), the UE is configured to receive PDSCH with the reduced-overhead UE-RS.

Alternatively, in an advanced system supporting the 3GPP LTE standards, a UE can be configured with a new transmission mode (TM), say TM X, which supports transmission schemes relying on a reduced-overhead UE-RS. Two alternatives are considered below, for the PDSCH reception of a UE configured with TM X:

Alt 1) When a UE is configured with TM X, the UE receives PDSCH with reduced-overhead UE-RS.
Alt 2) When a UE is configured with TM X, the UE receives PDSCH with reduced-overhead UE-RS if a first condition is met; with legacy UE-RS if a second condition is met. This alternative is explained in TABLE XIV below:

TABLE XIV
UE-RS indication

| Condition | UE-RS for the PDSCH |
|---|---|
| First condition | A first UE-RS pattern (e.g., reduced- |
| | overhead UE-RS). |
| Second condition | A second UE-RS pattern (e.g., legacy UE-RS). |

In one example, when the second condition is met, the UE-RS indication is done according to the legacy specification (i.e., according to TABLE VI); when the first condition is met, the UE-RS indication is done according to TABLE XV below:

TABLE XV
Antenna port(s), scrambling identity
and number of layers indication

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port a, n_{SCID} = 0 | 0 | 2 layers, ports a, b, |
| | | | n_{SCID} = 0 |
| 1 | 1 layer, port a, n_{SCID} = 1 | 1 | 2 layers, ports a, b, |
| | | | n_{SCID} = 1 |
| 2 | 1 layer, port b, n_{SCID} = 0 | 2 | 3 layers, ports a, b, c |
| 3 | 1 layer, port b, n_{SCID} = 1 | 3 | 4 layers, ports a, b, c, |
| | | | d |
| 4 | 2 layers, ports a, b | 4 | 5 layers, ports a, b, c, |
| | | | d, e |
| 5 | 3 layers, ports a, b, c | 5 | 6 layers, ports a, b, c, |
| | | | d, e, f |
| 6 | 4 layers, ports a, b, c, | 6 | 7 layers, ports a, b, c, |
| | d | | d, e, f, g |
| 7 | Reserved | 7 | 8 layers, ports a, b, c, |
| | | | d, e, f, g, h |

When the reduced-overhead UE-RS is used for rank 1 and 2, the reduced UE-RS can be used for MU-MIMO as well as single user MIMO (SU-MIMO). However, the reduced-overhead UE-RS may significantly degrade channel estimation performance when UE-RS are multiplexed with different scrambling IDs, because the interference randomization relying on scrambling may not be effective with the small number of UE-RS REs. Hence, removal of scrambling ID indication may be considered when reduced-overhead UE-RS is used. In this case, n_{SCID}=0 is always assumed for scrambling initialization, and the antenna port indication can be performed according to either TABLE XVI or XVII below instead of TABLE XV, when reduced-overhead UE-RS is configured.

TABLE XVI
Antenna port(s) and number of layers indication

| | |
|---|---|
| One Codeword: | Two Codewords: |
| Codeword 0 enabled, | Codeword 0 enabled, |
| Codeword 1 disabled | Codeword 1 enabled |

| Value | Message | Value | Message |
|---|---|---|---|
| 0 | 1 layer, port a | 0 | 2 layers, ports a, b |
| 1 | 1 layer, port b | 1 | 3 layers, ports a, b, c |
| 2 | 2 layers, ports a, b | 2 | 4 layers, ports a, b, c, |
| | | | d |
| 3 | 3 layers, ports a, b, c | 3 | 5 layers, ports a, b, c, |
| | | | d, e |
| 4 | 4 layers, ports a, b, c, | 4 | 6 layers, ports a, b, c, |
| | d | | d, e, f |
| 5 | Reserved | 5 | 7 layers, ports a, b, c, |
| | | | d, e, f, g |
| 6 | Reserved | 6 | 8 layers, ports a, b, c, |
| | | | d, e, f, g, h |
| 7 | Reserved | 7 | Reserved |

TABLE XVII
Antenna port(s), scrambling identity
and number of layers indication

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port a, n_{VCID} = 0 | 0 | 2 layers, ports a, b, |
| | | | n_{VCID} = 0 |
| 1 | 1 layer, port a, n_{VCID} = 1 | 1 | 2 layers, ports a, b, |
| | | | n_{VCID} ⁼ 1 |
| 2 | 1 layer, port b, n_{VCID} = 0 | 2 | 3 layers, ports a, b, c |
| 3 | 1 layer, port b, n_{VCID} = 1 | 3 | 4 layers, ports a, b, c, |
| | | | d |
| 4 | 2 layers, ports a, b | 4 | 5 layers, ports a, b, c, |
| | | | d, e |
| 5 | 3 layers, ports a, b, c | 5 | 6 layers, ports a, b, c, |
| | | | d, e, f |
| 6 | 4 layers, ports a, b, c, | 6 | 7 layers, ports a, b, c, |
| | d | | d, e, f, g |
| 7 | Reserved | 7 | 8 layers, ports a, b, c, |
| | | | d, e, f, g, h |

It is noted that in TABLE XVII a new parameter n_{VCID} is introduced for indicating a virtual cell ID (VCID) out of two higher-configured VCIDs. In this case, the pseudo-random sequence generator for the UE-RS sequence shall be initialised with

c(i)=(└ⁿ^{ₛ}/2┘+1)·(2n_{ID,i}⁽ⁿ^{_{VCID}}⁾+1)·2¹⁶

at the start of each subframe.

It is also noted that Alt 2 is motivated by the fact that reduced-overhead UE-RS is advantageous when signal-to-interference-plus-noise ratio (SINR) is high, and/or MCS is high, and/or rank is high; at the same time the reduced-overhead UE-RS may hurt the performance otherwise. According to these motivations, it may make sense to switch UE-RS patterns according to Method 1 as in the following.

Method 1:

The switching conditions for the UE-RS patterns depend on at least one of MCS and rank. In other words, the first and the second conditions are defined as at least one of threshold numbers associated with MCS and rank.

A few examples according to the method above are presented below:

### Example 1

When a UE is configured with TM X, the UE receives PDSCH with reduced-overhead UE-RS if the MCS configured in the PDCCH scheduling the PDSCH is greater than or equal to M; with legacy UE-RS if the MCS is less than M. In this case, the UE is indicated to use antenna ports according to the legacy table (i.e., TABLE VI) if the MCS is less than M, and according to the new table (i.e., one of TABLE XII, TABLE XIII and TABLE XIV) if the MCS is greater than or equal to M.

### Example 2

When a UE is configured with TM X, the UE receives PDSCH with reduced-overhead UE-RS if the rank configured in the PDCCH scheduling the PDSCH is greater than or equal to R; with legacy UE-RS if the rank is less than R.

In one example, R=3. Up to rank 2, APs 7 and 8 are used; the 8 APs for reduced overhead UE-RS are denoted by a, b, c, d, e, f, g, h and are used only when the rank is greater than or equal to 3. Then, the legacy antenna port indication table of TABLE VI can be revised into a new table as shown in TABLE XVIII below:

TABLE XVIII
Antenna port(s), scrambling identity
and number of layers indication

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, |
| | | | n_{SCID} = 0 |
| 1 | 1 layer, port 7, n_{SCID} = 1 | 1 | 2 layers, ports 7-8, |
| | | | n_{SCID} = 1 |
| 2 | 1 layer, port 8, n_{SCID} = 0 | 2 | 3 layers, ports a, b, c |
| 3 | 1 layer, port 8, n_{SCID} = 1 | 3 | 4 layers, ports a, b, c, |
| | | | d |
| 4 | 2 layers, ports 7-8 | 4 | 5 layers, ports a, b, c, |
| | | | d, e |
| 5 | 3 layers, ports a, b, c | 5 | 6 layers, ports a, b, c, |
| | | | d, e, f |
| 6 | 4 layers, ports a, b, c, | 6 | 7 layers, ports a, b, c, |
| | d | | d, e, f, g |
| 7 | Reserved | 7 | 8 layers, ports a, b, c, |
| | | | d, e, f, g, h |

### Example 3

When a UE is configured with TM X, the UE receives PDSCH with reduced-overhead UE-RS if the rank configured in the PDCCH scheduling the PDSCH is equal to R and the MCS is greater than or equal to M or if the rank is greater than R; with legacy UE-RS if the rank is less than R or if the rank is equal to R and the MCS is less than M. In this case, the UE is indicated to use antenna ports according to the legacy table (i.e., TABLE VI) if the rank is less than R or if the rank is equal to R and the MCS is less than M, and according to the new table (i.e., one of TABLE XV, TABLE XVI and TABLE XVIII) if the rank is equal to R and the MCS is greater than or equal to M or if the rank is greater than R.

### Example 4

The UE receives PDSCH with reduced-overhead UE-RS if both codewords are enabled and both MCS indices (I_{MCS}) for the two CWs are greater than or equal to M, where M is an integer; with legacy UE-RS otherwise. In one example, M is chosen such that 64 quadrature amplitude modulation (64QAM) is transmitted. In one example, M=18, which is the minimum MCS index associated with 64QAM (modulation order Qₘ=6) as seen from TABLE IX. In another example, M=28, which is the maximum MCS index associated with 64QAM. This option is motivated from observation that reduced overhead DMRS achieves a better throughput than the legacy DMRS when the rank is high and 64QAM are chosen for both CWs.

Method 2:

The switching conditions for the UE-RS patterns depend on whether a UE is indicated to use antenna ports that support MU-MIMO or not.

### Example

When a UE is configured with TM X, the UE receives PDSCH with reduced-overhead UE-RS if the layer indication does not explicitly include n_{SCID}; with legacy UE-RS if the layer indication explicitly includes n_{SCID}, as shown in TABLE XIX below. It is noted that this table has an advantage over other tables because it allows MU-MIMO multiplexing between advanced UEs and legacy UEs. The MU-MIMO codepoints, i.e., Values 0-3 for one-CW enabled case, and Values 0-1 for two-CW enabled case, are kept the same as the legacy table, i.e., TABLE VI.

TABLE XIX
Antenna port(s), scrambling identity
and number of layers indication

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, |
| | | | n_{SCID} = 0 |
| 1 | 1 layer, port 7, n_{SCID} = 1 | 1 | 2 layers, ports 7-8, |
| | | | n_{SCID} = 1 |
| 2 | 1 layer, port 8, n_{SCID} = 0 | 2 | 3 layers, ports a, b, c |
| 3 | 1 layer, port 8, n_{SCID} = 1 | 3 | 4 layers, ports a, b, c, |
| | | | d |
| 4 | 2 layers, ports a, b | 4 | 5 layers, ports a, b, c, |
| | | | d, e |
| 5 | 3 layers, ports a, b, c | 5 | 6 layers, ports a, b, c, |
| | | | d, e, f |
| 6 | 4 layers, ports a, b, c, | 6 | 7 layers, ports a, b, c, |
| | d | | d, e, f, g |
| 7 | Reserved | 7 | 8 layers, ports a, b, c, |
| | | | d, e, f, g, h |

Method 3:

For ensuring the best flexibility of eNodeB operation, a new one-bit field can be introduced in the DCI format scheduling the PDSCH (i.e., DCI format 2B/2C/2D and any DCI formats derived from these formats) for indicating a UE-RS out of the two. In this case, the indication of UE-RS is performed according to the following table.

TABLE XX

| State of the new one-bit field in the | |
|---|---|
| DCI format | UE-RS for the PDSCH |
| State 0 (e.g., 0) | Legacy UE-RS |
| State 1 (e.g., 1) | Reduced-overhead UE-RS |

Method 4:

Alternatively, for ensuring some flexibility of eNodeB operation and at the same time to reduce the PHY-layer signaling overhead, the UE-RS pattern information (TABLE XI) can be carried along with quasi co-location (QCL) information, which is included in the PDSCH RE Mapping and Quasi-Co-Location indicator (PQI) field in the DCI format 2D. In this case, the relevant section in TS 36.213 can be revised into:

The following parameters for determining PDSCH RE mapping and PDSCH antenna port quasi co-location are configured via higher layer signaling for each parameter set:
‘Number of CRS antenna ports for PDSCH RE mapping’.
‘CSI-RS resource configuration identity for PDSCH RE mapping’.
‘UE-RS pattern information’
   Here, the ‘UE-RS pattern information’ can indicate one of multiple configured UE-RS patterns.

In one example, the multiple configured UE-RS patterns are the legacy UE-RS and a reduced-overhead UE-RS.

In another example, the multiple configured UE-RS patterns are the legacy UE-RS and the NCT UE-RS.

In another example, the multiple configured UE-RS patterns are the legacy UE-RS, a reduced-overhead UE-RS and the NCT UE-RS.

In another example, the multiple configured UE-RS patterns are the legacy UE-RS, a first reduced-overhead UE-RS and a second reduced-overhead UE-RS.

In another example, the multiple configured UE-RS patterns are at least two of Patterns 1, 2, 3 and 4 in TABLE XXI or TABLE XXII below.

Method 5:

The channel estimation performance of reduced-overhead UE-RS can be improved when PRB bundling is applied. Hence, it is proposed that PRB bundling is always assumed when reduced-overhead UE-RS is configured. When PRB bundling is configured precoding granularity is multiple resource blocks in the frequency domain.

Switching Between a Reduced-Overhead DMRS Pattern and the Legacy UE-RS Pattern in the NCT

In one embodiment (embodiment 2), a serving cell of a first or a second type can be configured to an advanced UE capable of receiving/transmitting signals according to 3GPP LTE standards. The first type is the legacy carrier type (LCT) serving cell, and the second type is the NCT serving cell. Furthermore, the advanced UE can be configured with reduced-overhead UE-RS.

The advanced UE should support potentially four UE-RS patterns, i.e., Patterns 1, 2, 3 and 4 as shown in TABLE XVIII. Depending on the combination of the configurations, the UE support one out of the four patterns. For example, if the UE is configured with a serving cell of LCT, and the UE is configured with reduced overhead, the UE should assume Pattern 2 for PDSCH demodulation. It is noted that the UE-RS overhead configuration (or configuration of whether to use legacy or reduced-overhead UE-RS) can be performed according to some of the examples considered in embodiment 1.

TABLE XXI
UE-RS patterns for advanced UEs

| Configured UE-RS overhead/ | | |
|---|---|---|
| Configured serving-cell type | LCT | NCT |
| Legacy overhead (12 REs/PRB for | Pattern 1 | Pattern 3 |
| rank 1-2, 24 REs/PRB for rank 3-8) | | |
| Reduced overhead (<12 REs/PRB for | Pattern 2 | Pattern 4 |
| rank 1-2, <24 REs/PRB for rank 3-8) | | |

Pattern 1 is the same as the Rel-10 UE-RS pattern, depicted in FIG. 9.

An example of Pattern 2 is depicted in FIG. 10. Patterns 3 and 4 should be designed such that the UE-RS do not collide with PSS/SSS. When Pattern 2 is designed such that it also does not collide with PSS/SSS, Pattern 4 can be the same as Pattern 2. In that case, UE-RS pattern configuration for the advanced UEs would look like TABLE XIX.

TABLE XXII
UE-RS patterns for advanced UEs

| Configured UE-RS overhead/ | | |
|---|---|---|
| Configured serving-cell type | LCT | NCT |
| Legacy overhead (12 REs/PRB for | Pattern 1 | Pattern 3 |
| rank 1-2, 24 REs/PRB for rank 3-8) | | |

| | |
|---|---|
| Reduced overhead (<12 REs/PRB for | Pattern 2 |
| rank 1-2, <24 REs/PRB for rank 3-8) | |

UE-RS Power Boosting Aspects

FIGS. 11A through 11D explain UE-RS power boosting aspects of employing reduced-overhead UE-specific reference signals according to one embodiment of the present disclosure. In the LTE system, the number of REs per OFDM symbol per PRB pair is 12. When rank=1 or 2, the number of UE-RS REs per OFDM symbol per PRB pair is 3 in the legacy system (as shown in FIG. 9); the number is less than 3 in a reduced-overhead UE-RS pattern (for example, in FIG. 10, the number is 1).

In the legacy system, when rank=1 or 2, the same power is allocated to each UE-RS RE and each PDSCH RE for every antenna port. Suppose that the total available power in each OFDM symbol in a PRB pair is 12P. Then, each UE-RS RE and each PDSCH RE are assigned with the same power, i.e., P. This relation is illustrated in FIG. 11A.

In the legacy system, when rank=3 or above, twice large power is allocated for each UE-RS RE as the power for each PDSCH RE for every antenna port. When rank=3 or above, the number of PDSCH REs on an OFDM symbol where UE-RS is transmitted is 6, and the number of UE-RS REs in the OFDM symbol is 3. Suppose that the total available power in each OFDM symbol in a PRB pair is 12P. Then, each UE RS RE has power 2P, while each PDSCH RE has power P, and 3×2P+6×P=12P. This relation is illustrated in FIG. 11B.

This legacy power relation is captured in the legacy specification (TS 36.213 [REF3]) as in the following:
start (from 36.213)

For transmission mode 8, if UE-specific RSs are present in the PRBs upon which the corresponding PDSCH is mapped, the UE may assume the ratio of PDSCH EPRE to UE-specific RS EPRE within each OFDM symbol containing UE-specific RSs is 0 dB.

For transmission mode 9 or 10, if UE-specific RSs are present in the PRBs upon which the corresponding PDSCH is mapped, the UE may assume the ratio of PDSCH EPRE to UE-specific RS EPRE within each OFDM symbol containing UE-specific RS is 0 dB for number of transmission layers less than or equal to two and −3 dB otherwise.
end (from 36.213)

When the same power relation is applied to a reduced-overhead UE-RS as illustrated in FIG. 11C, the available power for the UE-RS goes down, which may degrades the link-level performance especially in the low SNR regime.

As an alternative to this baseline power allocation method, power boosting may be applied to the reduced-overhead UE-RS as illustrated in FIG. 11D, e.g., so that the same total power as in the legacy UE-RS can be kept in the OFDM symbol. Then, especially in relatively frequency-flat and time-flat channels, almost the same channel estimation performance may be achieved with the reduced-overhead UE-RS as the legacy UE-RS. At the same time, total power allocated to the PDSCH is maintained the same as the case of legacy UE-RS, but the number of REs allocated for the PDSCH increases. The increased number of REs for PDSCH may give us further coding gain, which may increase performance overall, regardless of high-SNR or not.

Method 6:

An advanced UE can be configured with traffic-to-pilot power ratio (or PDSCH EPRE to UE-RS EPRE power ratio) in the higher-layer signaling (RRC signaling), which indicates x decibels (dB) to assume for the traffic-to-pilot power ratio. The advanced UE assumes the configured power ratio when a reduced-overhead UE-RS is used; the advanced UE assumes the legacy power ratio when the legacy UE-RS is used. The indication of reduced-overhead UE-RS can be performed according to the methods in embodiments 1 and 2.

### Example

The RRC signaling message can indicate one dB value out of two values, e.g., {3 dB, 6 dB}.

Method 7:

The advanced UE assumes x dB power traffic-to-pilot power ratio when a reduced-overhead UE-RS is used, where x is (Alt 1) a constant or (Alt 2) determined as a function of the rank; the advanced UE assumes the legacy power ratio when the legacy UE-RS is used. The indication of reduced-overhead UE-RS can be performed according to the methods in embodiments 1 and 2.

### Example 1

Consider rank=1 or 2 first. When the one UE-RS RE in FIG. 11D takes power of 3P and the 11 PDSCH REs takes power of 9P, the traffic to pilot power ratio is (9P/11)/(3P)=3/11=−5.6 dB. Then consider rank=3 or higher. When the one UE-RS RE in FIG. 11D takes power of 6P and the 11 PDSCH REs takes power of 6P, the traffic to pilot power ratio is (6P/11)/(6P)=1/11=−10.4 dB. Then, x=−5.6 dB for rank=1 or 2; x=−10.4 dB for rank=3 or higher.

This example ensures that the UE-RS in the reduced-overhead UE-RS pattern has the same total power as the UE-RS in the legacy pattern. However, the large traffic-to-pilot ratio in case of rank=3 or higher may create inter-modulation/error vector magnitude (EVM) issues at the transmitter and the receiver.

To cope with these issues, other examples are considered below:

### Example 2

Regardless of rank (or for all rank=1, . . . , 8), the traffic to pilot power ratio is x=−5.6 dB.

### Example 3

Regardless of rank (or for all rank=1, . . . , 8), the traffic to pilot power ratio is x=−3 dB.

### Example 4

For rank=1 or 2, the traffic to pilot power ratio is x=−3 dB; for rank=3 or higher, the traffic to pilot power ratio is x=−6 dB.

### Example 5

Regardless of rank (or for all rank=1, . . . , 8), the traffic to pilot power ratio is x=−6 dB.

When power boosting is considered for reduced-overhead UE-RS, if all the UEs use the same reduced-overhead UE-RS pattern, then the boosted power collides in the same RE location all the time, which potentially nullify the gain of power boosting. To cope with the inter-cell or inter-user interference caused from the UE-RS power boosting, a UE-specific reduced-overhead UE-RS pattern may be allocated.

Method 8:

An advanced UE can be instructed to use a reduced-overhead UE-RS pattern out of a number of candidate reduced-overhead UE-RS patterns.

### Example 1

The UE can be instructed to use one out of three candidate reduced-overhead UE-RS patterns. FIG. 12 illustrates the three patterns in this example. The figure illustrates 12 REs in each OFDM with UE-RS within a PRB pair. When configured with a reduced-overhead UE-RS pattern, all the four OFDM symbols with UE-RS will be generated according to the reduced overhead UE-RS mapping pattern.

Which pattern out of the three patterns to be used for each PDSCH reception can be indicated to the UE by:
Alt 1: RRC configuration message (information element or information field).
Alt 2: Pattern i will be used when the physical cell ID

(PCI) of the serving cell satisfies (PCI mod 3)=i.
Alt 3: Pattern i will be used when the virtual cell ID (VCID, or n_{ID}⁽ⁿ^{_{RS}}⁾ to replace PCI in the UE-RS scrambling initialization) indicated for the PDSCH satisfies (VOID mod 3)=i.
Alt 4: The pattern is configured as one parameter for each PQI parameter set (as in Method 4).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A base station, comprising:
a transmitter configured to transmit demodulation reference signals (DMRSs) in a multi-user, multiple input multiple output (MU-MIMO) system according to a first DMRS antenna port (AP) mapping and according to a second DMRS AP mapping, wherein the base station is configured to switch between and selectively utilize one of the first and second DRMS AP mappings,
the first DRMS AP mapping defined for a legacy Long Term Evolution (LTE) wireless communications standard, and
the second DRMS AP mapping utilizing length 4 orthogonal cover codes (OCC-4) to multiplex orthogonal transmission of DMRSs for up to four user equipment (UEs).

2. The base station according to claim 1, wherein the second DRMS AP mapping comprises:

| | |
|---|---|
| One Codeword: | Two Codewords: |
| Codeword 0 enabled, | Codeword 0 enabled, |
| Codeword 1 disabled | Codeword 1 enabled |
| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7-9 |
| 3 | 1 layer, port 13 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-13 |

3. The base station according to claim 1, wherein the second DRMS AP mapping comprises:

| | |
|---|---|
| One Codeword: | Two Codewords: |
| Codeword 0 enabled, | Codeword 0 enabled, |
| Codeword 1 disabled | Codeword 1 enabled |
| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7, 8, 11 |
| 3 | 1 layer, port 13 | 3 | 4 layers, ports 7, 8, 11, |
| | | | 13 |
| 4 | 2 layers, ports 7, 8 | 4 | 5 layers, ports 7-11 |
| 5 | 3 layers, ports 7, 8, 11 | 5 | 6 layers, ports 7-12 |
| 6 | 4 layers, ports 7, 8, 11, | 6 | 7 layers, ports 7-13 |
| | 13 | | |
| 7 | Reserved | 7 | 8 layers, ports 7-13 |

4. The base station according to claim 1, wherein the base station is configured to select and utilize the second DRMS AP mapping when operating in a selected transmission mode.

5. The base station according to claim 1, wherein the base station is configured to select and utilize one of the first and second DRMS AP mappings based upon a value within a channel station information (CSI) process configuration field.

6. The base station according to claim 1, wherein first and second DRMS AP mappings each use a same number of resource elements (REs) per physical resource block (PRB) for DMRSs.

7. The base station according to claim 1, wherein the second DRMS AP mapping replaces entries including a scrambling identity in the first DRMS AP mapping with one or both of antenna port 11 and antenna port 13.

8. A method, comprising:
transmitting, from a base station in a multi-user, multiple input multiple output (MU-MIMO) system, demodulation reference signals (DMRSs) according to one of a first DMRS antenna port (AP) mapping and a second DMRS AP mapping, wherein the base station is configured to switch between and selectively utilize one of the first and second DRMS AP mappings,
the first DRMS AP mapping defined for a legacy Long Term Evolution (LTE) wireless communications standard, and
the second DRMS AP mapping utilizing length 4 orthogonal cover codes (OCC-4) to multiplex orthogonal transmission of DMRSs for up to four user equipment (UEs).

9. The method according to claim 8, wherein the second DRMS AP mapping comprises:

| | |
|---|---|
| One Codeword: | Two Codewords: |
| Codeword 0 enabled. | Codeword 0 enabled, |
| Codeword 1 disabled | Codeword 1 enabled |
| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7-9 |
| 3 | 1 layer, port 13 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-13 |

10. The method according to claim 8, wherein the second DRMS AP mapping comprises:

| | |
|---|---|
| One Codeword: | Two Codewords: |
| Codeword 0 enabled, | Codeword 0 enabled, |
| Codeword 1 disabled | Codeword 1 enabled |
| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7, 8, 11 |
| 3 | 1 layer, port 13 | 3 | 4 layers, ports 7, 8, 11, |
| | | | 13 |
| 4 | 2 layers, ports 7, 8 | 4 | 5 layers, ports 7-11 |
| 5 | 3 layers, ports 7, 8, 11 | 5 | 6 layers, ports 7-12 |
| 6 | 4 layers, ports 7, 8, 11, | 6 | 7 layers, ports 7-13 |
| | 13 | | |
| 7 | Reserved | 7 | 8 layers, ports 7-13 |

11. The method according to claim 8, further comprising:
selecting and utilizing the second DRMS AP mapping when operating in a selected transmission mode.

12. The method according to claim 8, further comprising:
selecting and utilizing one of the first and second DRMS AP mappings based upon a value within a channel station information (CSI) process configuration field.

13. The method according to claim 8, wherein first and second DRMS AP mappings each use a same number of resource elements (REs) per physical resource block (PRB) for DMRSs.

14. The method according to claim 8, wherein the second DRMS AP mapping replaces entries including a scrambling identity in the first DRMS AP mapping with one or both of antenna port 11 and antenna port 13.

15. A user equipment (UE), comprising:
a receiver configured to receive demodulation reference signals (DMRSs) in a multi-user, multiple input multiple output (MU-MIMO) system according to a first DMRS antenna port (AP) mapping and according to a second DMRS AP mapping, wherein the DMRSs are received from a base station configured to switch between and selectively utilize one of the first and second DRMS AP mappings,
the first DRMS AP mapping defined for a legacy Long Term Evolution (LTE) wireless communications standard, and
the second DRMS AP mapping utilizing length 4 orthogonal cover codes (OCC-4) to multiplex orthogonal transmission of DMRSs for up to four user equipment (UEs).

16. The UE according to claim 15, wherein the second DRMS AP mapping comprises:

| | |
|---|---|
| One Codeword: | Two Codewords: |
| Codeword 0 enabled, | Codeword 0 enabled, |
| Codeword 1 disabled | Codeword 1 enabled |
| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7-9 |
| 3 | 1 layer, port 13 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-13 |

17. The UE according to claim 15, wherein the second DRMS AP mapping comprises:

| | |
|---|---|
| One Codeword: | Two Codewords: |
| Codeword 0 enabled, | Codeword 0 enabled, |
| Codeword 1 disabled | Codeword 1 enabled |
| Value | Message | Value | Message |
|---|---|---|---|
| 0 | 1 layer, port 7 | 0 | 2 layers, ports 7, 8 |
| 1 | 1 layer, port 8 | 1 | 2 layers, ports 11, 13 |
| 2 | 1 layer, port 11 | 2 | 3 layers, ports 7, 8, 11 |
| 3 | 1 layer, port 13 | 3 | 4 layers, ports 7, 8, 11, |
| | | | 13 |
| 4 | 2 layers, ports 7, 8 | 4 | 5 layers, ports 7-11 |
| 5 | 3 layers, ports 7, 8, 11 | 5 | 6 layers, ports 7-12 |
| 6 | 4 layers, ports 7, 8, 11, | 6 | 7 layers, ports 7-13 |
| | 13 | | |
| 7 | Reserved | 7 | 8 layers, ports 7-13 |

18. The UE according to claim 15, wherein the UE is configured to receive the DMRSs according to the second DRMS AP mapping when operating in a selected transmission mode.

19. The UE according to claim 15, wherein the UE is configured to receive the DMRSs according to one of the first and second DRMS AP mappings based upon a value within a channel station information (CSI) process configuration field.

20. The UE according to claim 15, wherein first and second DRMS AP mappings each use a same number of resource elements (REs) per physical resource block (PRB) for DMRSs.
